(19) United States
(12) Patent Application Publication
(10) Pub. No.: US 2010/0153310 A1
(43) Pub. Date: Jun. 17, 2010

(54) DEVICE AND METHOD FOR ACCEPTING MAIL PIECES

(76) Inventor: Uwe Huebler, Neuenhagen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/635,203

(22) Filed: Dec. 10, 2009

(30) Foreign Application Priority Data
Dec. 12, 2008 (DE) 10 2008 062 002.5

(51) Int. Cl. G06F 17/00; G06K 5/00

(52) U.S. Cl. 705/408; 235/382; 235/375

(57) ABSTRACT

A device and a method for mail piece acceptance; with a mail item feed for mail pieces; with a user interface and with a accounting unit; with a card reader with cover plate into whose slit a postage credit card or an authorization card can be inserted; wherein after the settling the postage fee by the accounting unit a storage in secured storage containers in the storage region ensues; wherein the mail item feed is equipped with an adjustable opening of a feed shaft for depositing and for drawing in a mail piece; wherein the mail piece is an element of a set of mail pieces whose dimensions can be different; and the mail piece acceptance device has a number of devices for scanning the mail piece surface, for automatic position alignment of the mail piece, for transport, for printing a marking on the mail piece and for storage of the mail piece; wherein for storage a deflection of each of the mail pieces to a specific storage container ensues, which storage container is dimensioned corresponding to a size-accurate collection of mail pieces. The variable size of the adjustable opening of the mail item feed is set corresponding to the cost features input by the user.

### BACKGROUND OF THE INVENTION

1. Field of the Invention

The present invention concerns a device and a method for accepting mail pieces that is suitable for a mail processing machine that is set up in a post office, in stores, gas stations and/or at public squares or private facilities and used to accept mail pieces.

2. Description of the Prior Art

A device to process mail items is known from the European Patent EP 503 311 B1 that has standardized mail item feeds for mail items and an accounting unit. A postage credit card or an authorization card can be inserted into the accounting unit. After charging the postage fee via the accounting unit, a carriage block on the mail item feed is released. The mail item is then deposited in secured storage containers. Neither printing of a receipt voucher for the postal customers nor printing of a franking receipt on the mail piece ensues upon acceptance.

A method for mail item processing and a mail item processing system are known from the European Patent Application EP 1 058 212 A2 from the applicant Francotyp-Postalia GmbH.

An automatic mail item acceptance ensues at locations known as posting stations, and the mail distribution via a mail carrier after a franking of the mail item is prepared in dispensing stations, wherein a printing of a receipt voucher for the postal customers and a printing of a machine-readable marking on the mail piece ensue in each posting station. An input of additional relevant data into the first memory of the posting station occurs to buffer the marked mail item in the storage container of the posting station. The data are stored associated with the mail item due to the marking and can be retrieved again. The input can ensue with the use of a customer-related chip card that is plugged into a first read/write unit and is conducted to identify the customer-related chip card, or the customer. The retrieval of the data likewise ensues by means of the special first read/write unit, for example, by insertion of a carrier chip card to load the account data from the first memory n of a memory of the special carrier card. Emptying of the storage container of the posting station then ensues, followed by transport of the marked mail item and of the special carrier card via a first mail carrier to a remote franking machine in a dispensing station. After plugging the special carrier card into a second read/write unit and loading the accounting data from the memory of the special carrier card into a second memory of the franking machine, franking of the mail item in the dispensing station ensues corresponding to the data that are stored in the second memory associated with the marking information. The marking information is recovered from the scannable marking printed on the mail piece.

Three variants are proposed for the posting stations. The simplest variant is in the use of a storage container for mail pieces having a slot to insert a customer card and associated electronics, as well as a conventional customer receipt printer attached thereto. The customer receipt printer prints both the receipt and the marking on a self-adhesive paper strip. This makes it necessary for the strip with the marking to be adhered to the mail piece (possibly by the customer himself) before it arrives in the storage container. A remote dispensing station contains a marking reader and a franking machine system. The latter is formed by an automatic feed station, a dynamic weighing station and a franking station. The marking reader can be integrated into the franking machine system. The mail item processing system thus has a number of mail item dispensing stations and a number of mail item dispensing stations between which a (private) mail carrier operates in order to empty storage containers for mail pieces and carriage mail pieces to the mail item dispensing stations which conduct the franking of the mail items. If the mail item posting stations are of simple design, the mail item dispensing stations must be of more complex design, i.e. they must be equipped with additional stations (for example with a dynamic weighing station). Conversely, a mail item dispensing station can be of simple design (without scale) if the mail item posting stations already have a scale, i.e. are equipped in a more complex manner.

A number of variants for a mail item processing system are thus conceivable. It is disadvantageous that an overfilling of the mail item acceptance device is possible and conversely, since emptying of the mail item acceptance devices ensues at fixed time intervals, personnel may go to the postal station for emptying thereof even when no mail item has been deposited there at all. Moreover, stations with a scale are normally subject to obligatory calibration, which incurs increased maintenance costs.

In some of the most recent applications, business methods are disclosed according to which an object (article) is delivered from a shipping service provided to an article service provider who conducts its delivery (for example: United States Patent Application Publication No. 20080040208 A1). The use of a number of service providers in the transport of a mail article is costly.

Governmental postal authorities have submitted additional suggestions regarding new services and regarding the design or modification of existing services, causing new vending machines to be used ever more frequently. The problem of the “first mile” must be overcome, i.e. public and private letter services must first themselves receive the mail items in order to then be able to transport these items. Up to 2007, the Deutsche Post AG (DPAG) was obligated to operate at least 12,000 branches. As of the 2008 this is no longer legally mandated, and a mailing up to 50 g can now also be carried by competitors of the DPAG. As a practical matter, however, such competitors have difficulty operating in this niche.

While only smaller service operators or foreign low-wage services can operate as carriers, the DPAG solves this problem by automation by means of the new Post24/7 vending machines in addition to the known letter acceptance stations (formerly post offices) and mail boxes. The new Post24/7-type vending machines are coupled with stamp dispensers and mail boxes. The mail customer must first pull stamps from the stamp dispenser and adhere them to a mail piece, which can then be dropped into an adjacent, conventional mailbox by the postal customer. A package station is arranged at the rear of the Post24/7-type vending machine. An electrical package receptacle system and a method for its operation are known from European Patent EP 1408 802 B1 of the DPAG.

Registered customers can also send mailings at the Post24/7-type vending machine. They are then informed by e-mail/SMS and can collect the mailing independently of business hours.

The delivery of mail that has been franked by the customer is done by the postal authorities and the private carriers in many countries. The service providers are confronted with the task of reducing branch services or penetrating into markets in which the service provider has no branches. In order to completely replace branches, the letter acceptance devices must be calibrated as long as they determine a postage. However, if no postage is determined, this task to sort out mail pieces that have not been franked or have only been insufficiently franked by the postal client is shifted to the postal centers. The mode of operation of the letter acceptance devices must therefore be considered in connection with those of the postal centers.

The sorting in the mail center of the DPAG is implemented in a partially automated manner. In the letter center, after an alignment and positional orientation of the mail pieces, the mail pieces are assigned to categories according mailing types and are sorted according to length, width, height and weight. The mailing types of the DPAG are categories designated post cards, standard letters, compact letters, large letters and Maxibrief letters. The mailings are tossed into small bins (DE 10 2004 040 100 A1). It is advantageous if the letters are transported quickly on a belt. The manual sorting is complicated, and it would therefore be desirable if a portion of the sorting tasks is shifted outside of the letter center and implemented automatically.

Clearly all tasks cannot yet be taken over by vending machines. The Post24/7 vending machine of the DPAG thus does not sort any mail, even in part a limited manner. The need for pre-sorted mail for which rebates (discounts) are awarded by the government or private mail carriers which operate a distribution center could be met by private mail carriers that are upstream of the distribution center in the mail path.

An arrangement to generate a print image for franking and postmarking machines is known from the European Patent EP 1 519 325 B1 (corresponding to U.S. Pat. No. 7,186,040), wherein data for at least one first mail carrier are printed in predetermined sections of the print image on a strip label or on a mail piece, and wherein stations of a franking system for pre-sorting by the first mail carrier are operated at the first mail carrier. The mail pieces must be picked up by the first (private) mail carrier and then manually placed in the correct position at the feed station of the franking system.

However, if no additional private mail carrier should be interposed between the mail piece acceptance devices and the distribution center of the DPAG, the mail piece acceptance devices would have to determine the postage and measure the mail item characteristics of the item.

According to calibration laws, however, significant requirements exist for calibration-capable mail piece acceptance devices. These requirements lead to a significant cost and the solution is nevertheless subject to the disadvantages from the calibration law, for example the first calibration, recalibration, the maintenance of backup memory, and auxiliary devices.

At the beginning of December 2008, Deutsche Post AG officially started the nationwide “Briefstation” (“Letter Station”) pilot project for sites in Frankfurt am Main in Germany. Inside a vending machine, mail pieces are measured, weighed and franked with the use of the most modern techniques. The mail pieces (for example letters) can be placed individually or in stacks into the corresponding bin of the vending machine for franking. The letter station additionally has a letter box for mail pieces that are already franked, the drop opening of this letter box opening only when the customer has been identified by the customer's mail card. Moreover, the slot of the drop opening is larger than normal so that even mail pieces in the Maxibrief mail format can be dropped in. Moreover, the vending machine can also print stamps. The letter station can accept multiple thousands of letters by means of a special container system.

If a specific fill level is achieved before the daily emptying, the letter center responsible for an additional emptying is automatically notified. If a disruption should occur, the clever vending machine itself informs the technical service of this occurrence.

For letters with additional services, the shipping data is immediately provided for shipment tracking. The shipment status can be retrieved via the Internet portal “www.briefstatus.de” of Deutsche Post AG.

### SUMMARY OF THE INVENTION

An object of the present invention is to provide a method and a device for mail piece acceptance that process the mail piece and (even through the mail piece acceptance device has no scale) enable the application of a correct postage with the correct fee, in a correct orientation on the mail piece and on the correct side of the mail piece in a follow-up facility of a mail carrier.

The mail acceptance device should decentrally pre-sort the mail pieces, deposit them in the correct position and store them until pick-up, with the front and/or back side of every mail piece being scanned in the pre-sorting.

An imprint to simplify the further processing in the follow-up facility of a mail carrier should be printed on every mail piece by a printer of the mail piece acceptance device.

The mail piece acceptance devices should be protected from vandalism and their emptying thereof should occur on demand. Moreover, mail piece tracking should be enabled.

These objects are achieved in accordance with the invention by a mail piece acceptance device with a mail item feed for mail pieces that has an operating interface and an accounting unit and a card reader into which a postage credit card or an authorization card can be inserted. After the charging of the postage fee by the accounting unit, storage of the mail item in secure storage containers ensues in the storage region. The mail item feed is fashioned so as to be adjustable for the depositing of the mail item and to draw in the mail item, wherein the mail piece is a member of a set of mail pieces whose dimensions can be different. The mail piece can be inserted into the mail item feed in different feed positions and is automatically aligned in a specific position within the mail piece acceptance device before an identification.

The mail piece acceptance device has a number of devices for scanning the mail piece surface, for automatic position alignment of the mail piece, for transport, for generation of an identifier, billing and accounting as well as printing of a marking (identifier) on the mail piece, and for storage of the mail piece. For storage, each of the mail pieces is diverted to a specific storage container in the storage region that is dimensioned to collect mail pieces of the correct size. The mail piece acceptance device includes a first device to adjust the opening width of a closure of a feed channel to a second device for drawing the mail piece into the mail piece acceptance device, and a third device to scan the mail piece surface, and a fourth device for automatic position alignment of the mail piece, and a fifth device for printing, and a sixth device for transport and to divert mail pieces into the storage region for size-accurate collection. The storage region has a number of storage containers for storage of the mail pieces in the correct position (orientation). All of the aforementioned devices are connected in terms of operation with a controller. The operator interface is connected in terms of control with the first device via the controller in order to set a variable size of an opening (letter slot) in the closure of the first device corresponding to the input of fee-related features made by the user via the operating interface and via the controller. A mail piece depositing slot plate has a slot with the maximum allowable dimensions of a mail piece that are defined by the respective mail carrier.

The mail piece acceptance device has the following advantages. The preset slot size of the first device guarantees that the maximum allowable dimensions of the mail piece for this preset are not exceeded, which mail piece the user intends to insert into the mail piece acceptance device. The mail piece acceptance device contains no scale and thus is not subject to the calibration law with its disadvantages and requirements. A position alignment of the mail piece ensues independent of in which orientation the mail piece is placed into the depositing slot by the postal customer (operator). After the position alignment has ensued, a marking is printed by the printing device on the correct side and in the correct alignment of the mail piece, which marking contains the fee for the conveying service provider or postage value and an identifier. Moreover, diverse additional services can be provided, for example the determination of dimensions, the size-accurate pre-sorting and depositing of the mail pieces since relevant information for the later sorting process result due to the presetting of the slot size because aforementioned information is known due to the inputs of the postal customer at the mail piece acceptance device.

The method for mail piece acceptance includes the following steps. The customer number or authorization for operation of a mail piece acceptance device is automatically (electronically) identified. The pre-selection made by the operator is determined and the opening width of the depositing slot of the closure of the feed channel of the mail piece acceptance device is automatically set of a first device, The feed of a mail piece into the feed channel is detected by a first sensor of the first device emitting a signal upon the feed of an edge of the mail piece. The mail piece is automatically drawn into the feed channel by a second device. The scanning procedure of the surfaces of the mail piece is triggered by a third device for scanning in the feed channel. The position orientation of the mail item is automatically established by a fourth device for automatic position alignment of the mail piece, the automatic position alignment ensuing controlled by a sub-program of the controller according to the mail piece that has traversed the feed channel. Generating and storing an identifier number for the supplied mail piece, billing and accounting of the billing data associated with the identifier number, and printing a record as a receipt for the user, activating of a sixth transport device to transport the mail pieces to a printer of a fifth device in order to print the marking on the mail piece, activating of the sixth transport device for mail pieces and corresponding deflectors gates on the transport belt for transportation up to the storing the mail piece, storing the mail piece; and sealing the closure if no additional mail piece is to be deposited, or depositing an additional mail piece if a user authorization for this is present.

The accounting of the billing data includes at least the identification data of the user and a postage value for the subsequent carriage and delivery by the mail carrier of the mail piece processed by means of the mail piece acceptance device. The marking printed on the mail piece includes the previously generated identification number.

To achieve the additional objects, a data connection is furthermore provided for data transmission to the distribution center so that at least information can be stored in the distribution center indicating one or more of:

(a) specific letters are present in the mail piece acceptance device,

(b) the mail piece acceptance device must be emptied,

(c) how the further mail piece processing should ensue or

(d) at exactly which point in the mail path the mail piece is located.

The decentralized scanning in the third device has the advantage that the information is already present in the distribution center when the mail piece arrives at the distribution center; so more time is available for the central evaluation of the information. Only the letter identification is then read in the distribution center. Due to the letter identification, the data sets associated with the letter can be used in the distribution center in order to organize the distribution and delivery of the mail pieces.

In one variant, an additional read station (OCR) is arranged in the third device for scanning the mail piece surface so that all track-and-trace information required for mail piece tracking can be determined in a decentralized manner. This leads to a further advantage: the data sets transmitted via a communication device to a data center of the distribution center of the mail carrier in connection with the marking (identifier) of scanned front sides and back sides by the mail acceptance device enable a centralized evaluation in the distribution center without the mail pieces having to be again rescanned there.

The mail piece acceptance device is characterized by a simple operation capability by a user and the following mode of operation.

After a first Query Step for user input, an identification of the customer number or authorization for operation of the mail piece acceptance device ensues in a second step; the user of the mail piece acceptance device is then prompted to preselect the opening width of the depositing slot of the closure of the feed channel of the mail piece acceptance device, wherein the pre-selection is queried in query steps; a setting of the opening width of a closure of the feed channel subsequently ensues in a sub-program corresponding to the pre-selection corresponding to one of the mail formats permitted by the mail carrier. Feed of a mail piece into the feed channel ensues when a sensor of a first device to vary the opening width of the closure at the input of the feed channel emits a signal upon feeding of an edge of the mail piece. Drawing of the mail piece into the feed channel by means of a second device to draw in the mail piece ensues upon feeding, and a triggering of the scanning procedure of the surfaces of the mail piece ensues by means of a third device in the feed channel, wherein the position of the supplied mail piece is detected by means of a sub-program, and wherein an identifier number for every scanned subject is generated as necessary and is stored associated with the supplied mail piece. Establishment of a predetermined position orientation by means of a sub-program in the controller and by means of a fourth device for automatic position orientation and alignment subsequently ensues after the mail piece has traversed the feed channel, as well as an output to a sixth transport device to transport the mail pieces to a printer of a fifth device and its activation in order to print a generated identifier on the mail piece.

The billing ensues following the operating instructions of the user, for example by means of a postal security device as a accounting unit of the mail piece acceptance device or via a similar secure data processing device and in connection with an infrastructure, for example such as are already known in the field of franking.

The activation of the sixth transport device for mail pieces and of corresponding deflectors on the transport belt for transport up to the storage of the mail piece ensues subsequently after the printing.

### BRIEF DESCRIPTION OF THE DRAWINGS

FIG. 1a is a perspective representation of a first variant of a mail piece acceptance device from the front, top right.

FIG. 1b is schematic representation of the module arrangement of the mail piece acceptance device.

FIGS. 2-I, 2-II, 2-III, 2-IV show different feed positions for mail pieces at the mail piece acceptance device.

FIG. 3a shows mail piece depositing slot plate in a front view.

FIG. 3b is a front view of a device for setting the opening width of the closure of the feed channel for mail pieces having a small opening width, and shows the basic arrangement of modules to activate the closure mechanism.

FIG. 3c is a front view of a device for setting the opening width of the closure of the feed channel for mail pieces having a large opening width, and shows the basic arrangement of modules to activate the closure mechanism.

FIGS. 4a-I, 4a-II, 4a-III, 4a-IV show different feed positions of the mail pieces at the mail piece acceptance device.

FIGS. 4b-I, 4b-II, 4b-III, 4b-IV are plan views of a device for positionally accurate alignment of the mail pieces, presented in a simplified manner.

FIGS. 4c-I/III, 4c-II/IV are plan views of a device for positionally accurate alignment shown in a simplified manner, before and after output of the mail piece in the output position and upon printing during the transport of the mail piece in the x-direction.

FIGS. 5a-I, 5a-II, 5a-III, 5a-IV are simplified representations of the plan view of the rotating plate with pivot device after a quarter rotation of the pivot device on an axis parallel to the x-direction.

FIGS. 5b-I, 5b-II, 5b-III, 5b-IV are simplified representations of the plan view of the rotating plate with pivot device after a quarter rotation of the rotating plate on an axis parallel to the z-direction.

FIGS. 5c-I, 5C-II, 5c-III, 5c-IV are plan views of a mail piece in the output position.

FIG. 6a is a plan view of a device for positionally accurate alignment of mail pieces in the x/y plane, with a rotating plane and with a pivot device, in the feed phase of a mail piece.

FIG. 6b is a side view of the feed channel and of the pivot device in the x/z plane.

FIG. 6c is a front view of the device for positionally accurate alignment of mail pieces in the y/z plane, with a rotating plane and with a pivot device, in the feed phase of a mail piece.

FIG. 6d is a side view of the pivot device in the x/z plane.

FIG. 6e is a front view of the device for positionally accurate alignment of mail pieces in the x/z plane, in a phase after the pivoting of a mail piece.

FIG. 6f is a side view of the device for positionally accurate alignment of mail pieces in the x/z plane after a quarter rotation of the rotating plate on an axis parallel to the z-direction.

FIG. 6g is a side view of a mail piece in the output position during transport in the x-direction out of the pivot direction.

FIG. 7a is a perspective representation of a second variant of a mail piece acceptance device from the front, top right.

FIG. 7b is a simplified representation of a plan view of the rotating plate with mail piece in the transport path in the x-direction to the printing according to a second variant of the mail piece acceptance device.

FIG. 7c is a front view of the rotating plate with pivot device and mail piece in phases that proceed in the second variant of the mail piece acceptance device.

FIG. 8 is a flowchart of an embodiment operation of the mail piece acceptance device.

FIG. 8a is a flowchart of a sub-program to set the depositing opening of the mail piece acceptance device.

FIG. 8b is a flowchart of a sub-program for the scanning of the front side and back side of a mail piece in the mail piece acceptance device.

FIG. 8c is a flowchart for sub-programs for the position alignment of a mail piece in the mail piece acceptance device; for the generation of an identifier or, respectively, billing number; for billing of the mail piece shipping job; for accounting of the carriage fee; for printing of the identifier; if necessary for printing out a receipt; and for storage in a storage container.

### DESCRIPTION OF THE PREFERRED EMBODIMENTS

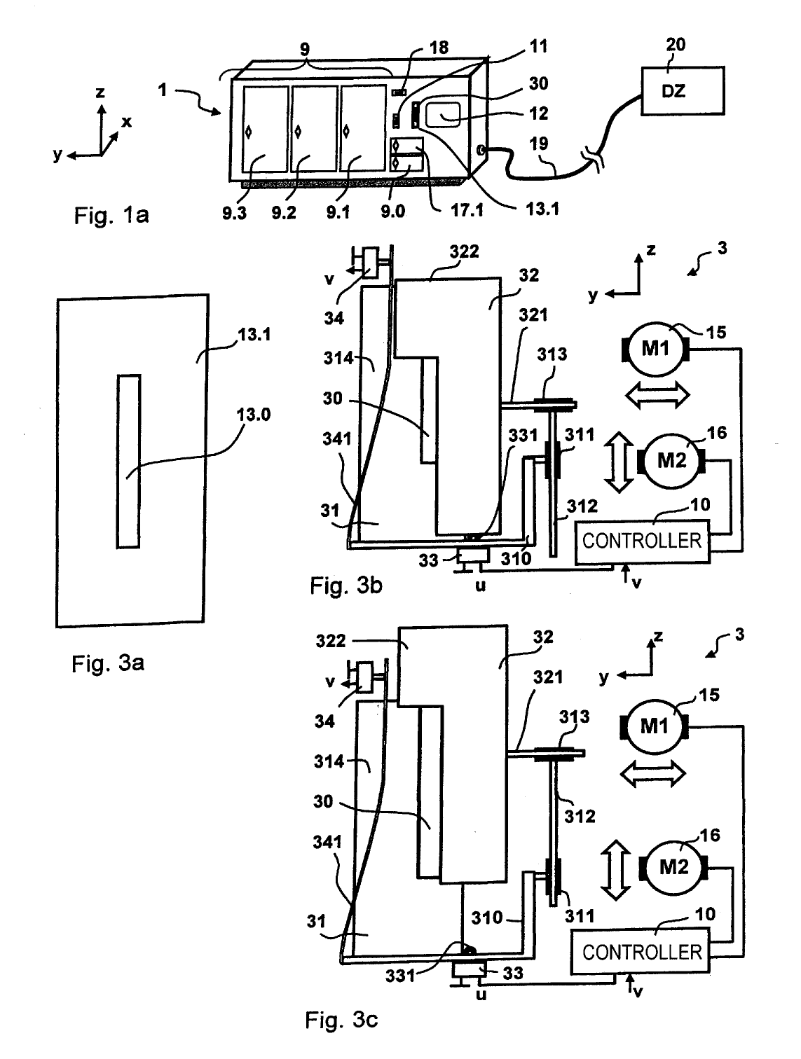

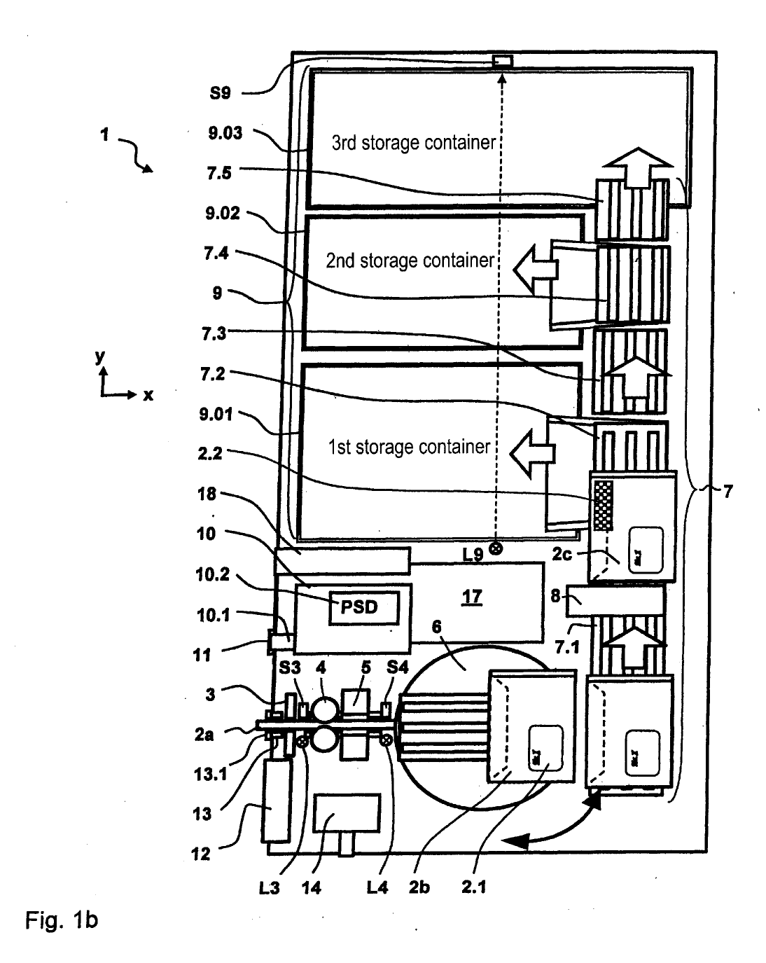

A perspective view of the mail piece acceptance device 1 from the front, top right in a first variant is shown in FIG. 1a. Said variant has a height (i.e. an extent in the z-direction), a depth (i.e. an extent in the x-direction) and a width (i.e. an extent in the y-direction) of an orthogonal coordinate system. The mail piece acceptance device 1 has a quadratic, cabinet-shaped structure with accesses 9.1, 9.2, 9.3 to a number of chambers, each with a storage container as well, and optionally with an access 9.0 to a waste container; said accesses are externally accessible and can be locked and unlocked by means of locking means. The storage region 9 occupies the majority of the volume of the mail piece acceptance device. The accesses 9.1, 9.2, 9.3 serve for the emptying of the storage region by a mail carrier organization. Although only 3 accesses are indicated, additional accesses to the mail piece storage chambers can adjoin to the left in the y-direction. The following parts are arranged on the front side, near the right side: a card reader cover plate 11, a user interface 12, a mail piece depositing slot plate 13.1, a receipt output device 18, and a flap 17.1 of a mail piece return bin to return unprocessed mail pieces to the operator (postal customer). The height of the mail piece acceptance device 1 advantageously corresponds to at least the average body height of the users, such that all actions of the user at the card reader, at the user interface, at the mail piece depositing slot, at the receipt output and at the flap of the mail piece return bin can be conducted at an ergonomically advantageous height. The depth of the mail piece acceptance device 1 advantageously corresponds to at least double the length of a longest mail piece. The mail piece depositing slot plate 13.1 serves as a cover of a variable opening 30 of the supply shaft and possesses a centrally arranged slot 13.0 that serves for the depositing and acceptance of mail pieces and possesses constant dimensions which correspond to the dimensions of the largest mail piece allowed for carriage by the postal carrier. The mail piece acceptance device 1 is connected via a data cable 19 to a data center 20 for communication with said remote data center via a communication device 14, wherein a wired communication with other communication devices is enabled via a telephone network, for example.

Alternatively, a communication device in the mail piece acceptance device 1 can also be operated without data cable, for example via Bluetooth communication protocol or via a different type of wireless communication with other communication devices, for example via WLAN.

In addition to the configuration of the first variant that is described above, at least one other configuration of a second variant of the mail piece acceptance device that is explained further below can also be realized.

The first variant is explained in detail using FIG. 1b, which shows a schematic representation of the module arrangement of the mail piece acceptance device 1 of said first variant. The mail piece acceptance device 1 advantageously of the following components.

A first device 3 sets the opening width of the closure of the feed channel 13 that has a mail piece depositing slot plate 13.1 at its front side.

A second device 4 draws mail pieces 2a into the feed channel 13.

A third device 5 scans the position of a mail piece in the feed channel, such as by optical scanning, and acquires data of either the address side and/or the back side and/or both sides of the mail pieces 2a.

A fourth device 6 automatically orients and aligns the position of a mail piece 2b.

A fifth device 8 prints a marking 2.2.

A sixth device 7 transports and diverts the mail pieces 2c for the size-accurate collection of mail pieces in a storage region, wherein the mail pieces 2c have a predetermined alignment during transport and reach a first deflector, or first and second deflector 7.2 and 7.4, or a number of deflectors 7.2, 7.4, . . . , 7.x which serve to divert mail pieces in the storage region 9 with size-accurate collection. The storage region 9 has a number of storage containers 9.1, 9.2, 9.3 for positionally accurate storage of the mail pieces 2c.

A seventh device 14 communicates with a data center 20.

An eighth receipt output device 18 has a printer 18.1 for printing receipts/confirmations with regard to various parts of the workflow.

A user interface 12 allows the user to provide mailing parameters, mail piece properties or information, for example pre-payment values, count, shipping properties, mail item features etc.

A card reader cover plate 11 covers a debit or credit card reader 10.1 and a postal security device 10.2 for accounting.

The acceptance device also has a mail piece return bin 17.

A controller 10 of the devices is connected in terms of operation with the aforementioned devices 3 through 8, with the credit card reader 10.1, with the postal security device 10.2, with the user interface 12, with the communication device 14, with the receipt output device 18, and with the printer 18.1.

The mail piece acceptance devices can advantageously be installed in existing postal branches or using other existing infrastructures, for example at gas stations, lottery receiving offices etc. The possibility is therefore provided

to accept mail pieces or, respectively, letters,

to identify mail pieces or, respectively, letters,

to sort mail pieces or, respectively, letters in storage containers according to size and in the correct position, i.e. to store them in a defined position,

possibly to read and to process addresses on mail pieces,

to inform the mail carrier (letter service) when a pickup time or, respectively, predetermined fill level is reached so that this carrier can empty the letter acceptance device on demand.

Every mail piece acceptance device contains a mail piece return bin 17 as an additional mail piece buffer from which unprinted mail pieces or letters can be removed via a flap 17.1 after termination of the process by the user. The termination of the process can also ensue automatically, for example if: the position of the mail piece or, respectively, letter is not detected; the latter is too small with regard to the dimensions allowed for carriage; or the user cannot provide the fee required for carriage. The articles are deposited into a separate container when its extraction from the mail return bin by the user does not occur. The separate container (not shown) can subsequently be emptied via a flap 9.0. Advantageously, no personnel in the postal branch or similar facilities are required, whereupon corresponding cost advantages arise. Those cost advantages which arise upon maintenance are particularly noted. Maintenance incurs a lower cost since the mail piece acceptance device contains no scale.

A user inserts his debit, credit, balance or customer card into the slot of the card reader cover plate 11 of the letter acceptance device. An input of a PIN optionally ensues after the insertion of the card. The user is identified with this and an accounting (billing) is possible. The user inputs a postage value or the information for the service provider about the dimensions of the mail piece, and possibly a number of mail pieces to be franked, via touch screen or via keyboard, for example. The arrangement is therefore no longer subject to obligatory calibration since no scale is present.

The closure of the (slot) feed channel 13 is opened by the first device 3.

The mail pieces 2a are inserted in succession into the slot of the plate 13.1 and land in the feed channel 13. They are drawn in by the latter into the mail piece acceptance device. A detection of the orientation of the mail pieces thereby ensues before the establishment of a different orientation and alignment. An image of the front side and back side arises as a result in the controller 10, from which information regarding the present orientation of the mail piece is derived. The orientation of the mail piece that is required for printing with the fee is subsequently established with the fourth device 6 according to the invention, controlled by the controller 10 which also contains a billing and accounting unit.

The now positionally accurate mail piece is supplied for postage of the printing device 8 and marked in that it is printed with at least the fee and an identifier that subsequently delivers suitable information to the service provider.

The devices 3 through 8 contain sensors and actuators that are operationally connected with the controller 10—which was not shown in detail in FIG. 1b for reasons of clarity. A first photoelectric barrier L3-S3 is arranged at the start of the feed channel within or near to the first device 3. A sensor S3 of the first photoelectric barrier emits a signal upon feed of an edge of the mail piece and is electrically connected (not shown) with the controller, which determines the feed of a mail piece into the feed channel. The sensor S3 receives light from a light source L3 until the light beam is interrupted by a mail piece. A second photoelectric barrier L4-S4 is arranged at the end of the feed channel 13 and signals the end of the feed of the mail piece. A sensor S4 of the second photoelectric barrier receives light from a light source L4 until the light beam is interrupted by a mail piece. The latter is the case when a predetermined position of the mail piece is reached which can as needed trigger a blocking of the feed channel 13 via a closing of the closure of the first device 3 in the event that no additional mail piece should be supplied. The sensors and actuators of the devices are all connected (not shown, but in a known manner) with the controller 10 and are later explained in connection with the function of these devices. An additional photoelectric barrier S9-L9 arranged in the storage region 9 can, for example monitor all storage containers at once as to whether one of the containers is already full. A sensor S9 receives light from a light source L9 until a predetermined fill level of one of the storage containers 9.01, 9.02 and 9.03 is reached.

The billing ensues directly with the beginning of the printing in the postal security device 10.2 and/or either directly, immediately via the communication device 14 by means of a data connection to the remote data center, or ensues in a consolidated manner at a later point in time.

The security device 10.2 receives and stores the count and/or properties of the mail pieces that are associated with the user. A receipt print can be provided to the user as needed.

In a further embodiment, an OCR reader is also contained in the third device 5 that scans the information on at least one side (advantageously the address side) of the mail piece, which information is received by controller 10. The controller has a corresponding user program. With a read address, a suitably applied identifier and the association of the two features with one another, a mail piece tracking function (which is also known as “track and trace” can be realized with the service provider in a further processing step.

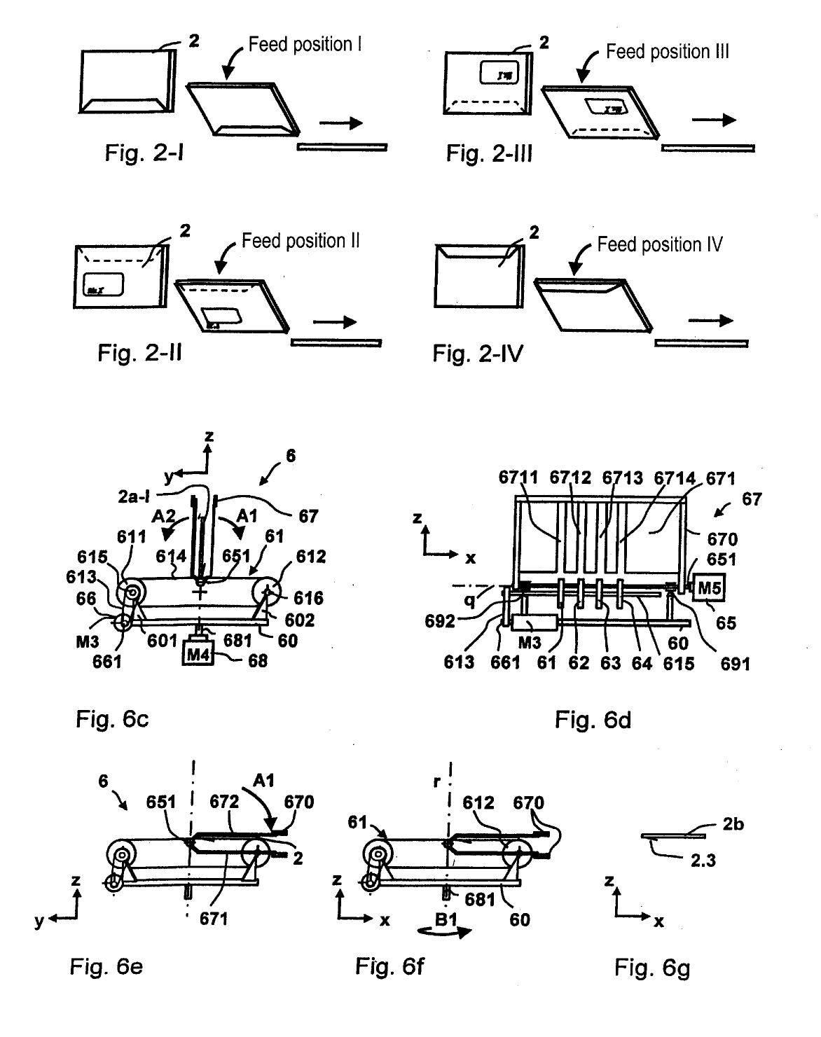

FIGS. 2-I, 2-II, 2-III, 2-IV show different feed positions for mail pieces at the mail piece acceptance device. The presentation shows the plan view of a mail piece lying in different starting positions and rotated into different feed positions I, II, III or IV. The mail piece is located in the starting position, lying, for example,

in FIG. 2-I—on the front side with the flap on the lower longitudinal edge,

in FIG. 2-II—on the back side with the flap on the upper longitudinal section edge,

in FIG. 2-III—on the back side with the flap on the lower longitudinal edge or

in FIG. 2-IV—on the front side with the flap on the upper longitudinal edge.

In the feed position the mail piece is located standing on the longitudinal edge, for example

in FIG. 2-I—with the flap forward and on the lower longitudinal edge,

in FIG. 2-II—with the flap to the rear and on the upper longitudinal edge,

in FIG. 2-III—with the flap to the rear and on the lower longitudinal edge,

in FIG. 2-IV—with the flap forward on the upper longitudinal edge.

A mail piece 2 (in particular an envelope) can, for example, be situated on a table (not shown) in any of the possible different starting positions and is rotated by the operator into one of the shown feed positions I, II, III or IV before being deposited into the slot of the mail piece acceptance device, wherein the opening width of the closure is set by the first device.

FIG. 3a shows a front view of a plate with a slot for depositing mail pieces. A mail piece depositing slot plate 13.1 with a slot 13.0 for depositing mail pieces (standing on edge, for example) is mounted on the front side of the mail piece acceptance device. The slot 13.1 has the dimensions 50 mm·250 mm. For example, Deutsche Post AG carries mail pieces with the following maximum dimensions (mail format):

| Abbreviation | Designation | Height | Width | Length |
|---|---|---|---|---|
| M | Maxibrief | 50 mm | 250 mm | 353 mm |
| G | Large Letter | 20 mm | 250 mm | 353 mm |
| K | Compact Letter | 10 mm | 125 mm | 235 mm |
| S | Standard Letter | 5 mm | 125 mm | 235 mm |

The smallest mail piece should thereby not fall below a minimum measurement of 70 mm·100 mm or, respectively, 90 mm·140 mm (standard letter).

A letter slot for a Maxibrief measures at most 50 mm·250 mm. A letter slot for a large letter measures at most 20 mm 250 mm. A letter slot for a compact letter measures at most 10 mm 125 mm. A letter slot for a standard letter measures at most 5 mm·125 mm.

In spite of the customary designation “letter”, this deals more precisely with the formats of the envelopes or, respectively, protective mail piece casing or, respectively, packaging, or post cards.

The medium of the letter content is usually a piece of paper of commercial dimensions (normal formats). In Germany, standards (known as DIN formats) apply for standard formats. The initial format is selected so that every halving retains the original page ratio, which is not the case with other formats. A-0 is the original format. The DIN-A series is preferred, while the auxiliary series B and C have formats dependent on the A series and then serve for enclosing or processing of the A series.

### The Paper Formats of the DIN Series in mm:

| DIN | Series A | Series B | Series C |
|---|---|---|---|
| 0 | 841 × 1189 | 1000 × 1414 | 917 × 1297 |
| 1 | 594 × 841 | 707 × 1000 | 648 × 917 |
| 2 | 420 × 594 | 500 × 707 | 458 × 648 |
| 3 | 297 × 420 | 353 × 500 | 324 × 458 |
| 4 | 210 × 297 | 250 × 353 | 229 × 324 |
| 5 | 148 × 210 | 176 × 250 | 162 × 229 |
| 6 | 105 × 148 | 125 × 176 | 114 × 162 |
| 7 | 74 × 105 | 88 × 125 | 81 × 114 |
| 8 | 52 × 74 | 62 × 88 | 57 × 81 |
| 9 | 37 × 52 | 44 × 62 | 41 × 57 |
| 10 | 26 × 37 | 31 × 44 | |
| 11 | 18 × 26 | | |

Typically three size groups are differentiated when mail pieces should be sorted into containers according to size and a waste or, respectively, return container (which is designated in the following as a 0^{th} container).
0^{th} container: All smallest mail pieces or, respectively, articles which fall below a minimum dimension of 70 mm·100 mm in width or length.
1^{st} container: All envelopes for Maxibriefs or large letters, i.e. larger C4-format and B4-format mail pieces (everything which is larger than or equal to C4). A Maxibrief may not exceed a height of 50 mm.
2^{nd} container: All small envelopes. The envelope for a small, “normal” letter and post cards in Germany is 162 mm long and 114 mm wide and thus corresponds to the C6 format. Envelopes of 220 mm in length, i.e. approximately of C5 length, are also typical with the same width. A standard letter may not exceed a height of 5 mm.
3^{rd} container: all envelopes for letters and mail pieces which should not be deposited into the other containers 1 or 2 or be separated out into the 0^{th} container. A compact letter may not exceed a height of 10 mm.

FIG. 3b shows a front view of a device 3 for setting the opening width of the closure of the feed channel for mail pieces given a small opening width, and the principle arrangement of modules for the activation of said device 3. The closure is formed by first and second closure jaws 31 and 32 and, controlled by a controller 10, driven by a first motor (M1) 15 and second motor (M2) 16. In a first variant, the closure is kept completely closed as long as the user has not identified himself or herself. The mail piece acceptance devices can thereby be effectively protected from anonymous depositing of articles that could cause damage. As soon as the user has identified himself or herself, the user can be held responsible and therefore be made liable for damages that the user has caused or which are based on verifiable vandalism.

In a further variant (without vandalism protection), the closure is never entirely closed and a slot always remains for mail pieces (letter slot) which have the smallest possible dimensions allowed by the postal carrier. The device 3 can therefore also be designated in a shorter form as a slot size adjustment device. The closure has a quadratically shaped opening 30 (letter slot) and two immediately adjacent, unmovable sides as well as two immediately adjacent movable sides in order to be able to enlarge the letter slot.

The movable sides are formed by a movable, L-shaped closure jaws 32 which are situated opposite an L-shaped closure jaws 31 that is arranged immobile on a chassis 310, wherein the movable closure jaws 32 have an L-shape rotated by 180° to the right and are arranged opposite the unrotated L-shaped closure jaws 31. Attached or molded on the chassis 310 at a distance from and opposite to the unrotated L-shaped closure jaws 31 is a bearing 311 which serves to guide a first sled 312 in the z-direction and opposite this. The movement is thereby transferred from the second motor 16 via a drive device (not shown) to the first sled 312. The first sled 312 carries a second bearing 313 for a second sled 321. The latter is driven in the y-direction by the first motor 15 via a drive device (not shown) and moved opposite to this. The second sled 321 is molded or, respectively, rigidly mounted on the outside of the movable, rotated closure jaws 32 with which at least one movement in the y-direction or opposite to this is transferred to the closure jaws 32. Each of the two closure jaws has an L-shape, i.e. a shorter arm 322 bent at a right angle from the longer arm.

The motors 15 and 16 can be fashioned as step motors M1 and M2. After emission of a number of activation pulses to the step motors M1 and m2 by the control unit 10, a predetermined opening width of the closure can be achieved as of an end point. Two end position switches 33 and 34 are fashioned as microswitches, for example, and emit a signal to the controller when the movement reaches an end point. The end of the shorter arm 322 of the second closure jaws 32 is, for example, driven in the y-direction up to the longer arm 314 of the first closure jaws 31 and reaches its end position when the end of the shorter arm 322 of the second closure jaws 32 activates the second end position switch 34, wherein the latter emits a ground signal to the controller 10 via its output u. Given a movement of the closure jaws 32 near the end position on the switch in the z-direction and opposite to this, a mechanically induced wear could occur on the switching knob of the second end position switch 34. An elastic actuation lever 341 is inserted between the closure jaws 32 and the second end position switch 34 to reduce the abrasion. A ball or a wheel 331 that is borne such that it can rotate is used at the end of the switching knob of the first end position switch 33.

In an alternative sub-variant (not shown) of the first variant, the closure is formed by two movable jaws.

In an alternative, additional sub-variant (not shown) of the first variant, the closure is driven either by alternative electromagnetic actuators (such as operating magnets, linear motors etc.) or by pneumatically operated actuators.

FIG. 3c shows a front view of a device to adjust the opening width of the closure of the feed channel for mail pieces given a large opening width and principle arrangement of modules for its activation. The L-shaped, movable closure jaws 32 of the closure that are rotated by 180° to the right were moved by means of the first sled 312 and the second sled 321 into a position that corresponds to a maximum opening width of the closure of the feed channel for mail pieces.

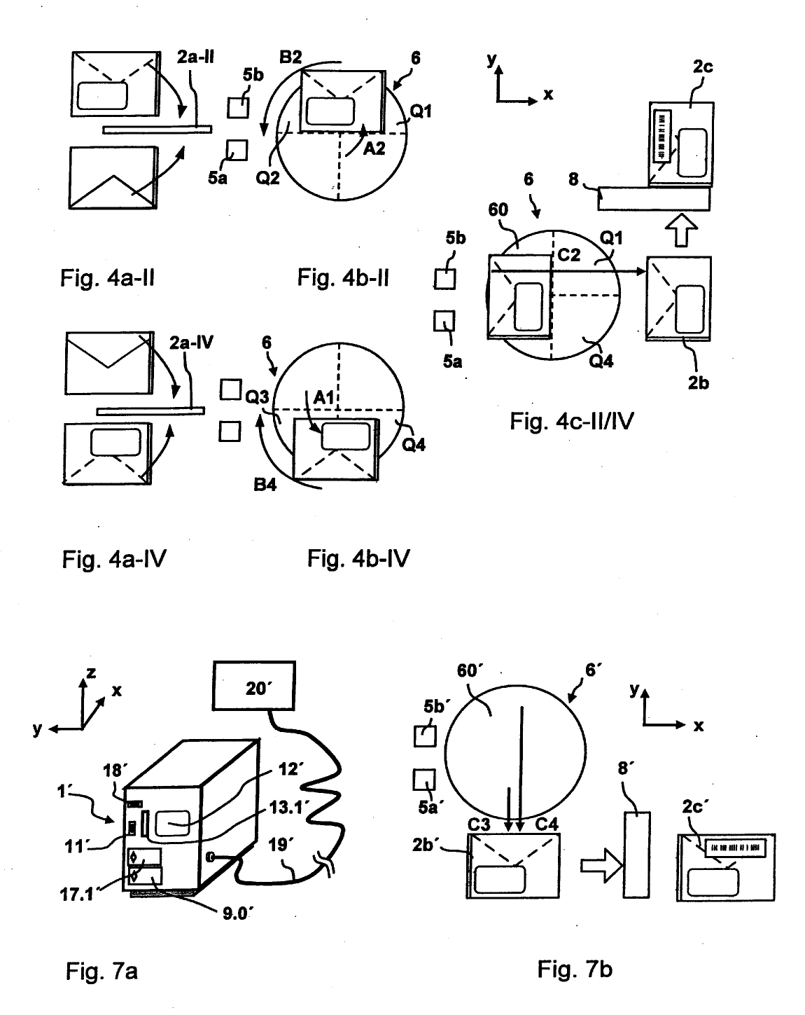

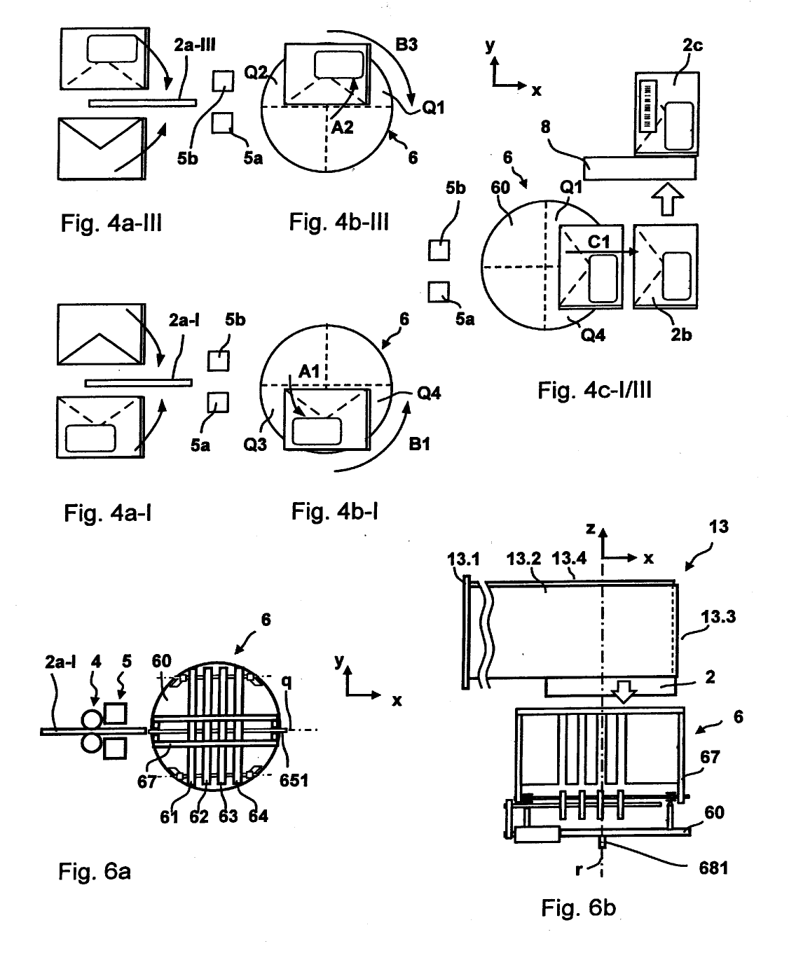

FIGS. 4a-I, 4a-II, 4a-III, 4a-IV show a representation of different feed positions I through IV of the mail pieces 2a given feed into a channel (not shown) of the mail piece acceptance device in plan view on the x/y plane. The respective starting position shown at the top left in FIGS. 4a-I, 4a-II, 4a-III, 4a-IV corresponds to that which was already explained using FIGS. 2-I, 2-II, 2-III, 2-IV. A number of possible starting positions exist, not all of which are shown herein. The additional starting position is shown at the lower left. The multiple possible starting positions indicate that not just a single starting position occurs in practice. The mail piece is manually rotated for the purpose of feeding, and in fact such that it fits into the depositing slot. An insertion into the depositing slot of the mail piece acceptance device is possibly only in a longitudinal orientation for large mail formats (Maxibriefs and large letters). Given a transversal orientation of large mail formats, its length would exceed the set height of the depositing slot of the closure. They can therefore not be inserted into the depositing slot of the closure of the feed channel of the mail piece acceptance device in transversal position. Given small mail formats (compact and standard letters), the transversal position would only be possible if the opening width of the depositing slot had been set to be too large. The feed position is scanned by the scanning device 5a, 5b. Transversal positions of the mail piece can be detected in principle and be provided for subsequent rejection and return via return bin.

As an alternative to the return, the processing of mail pieces in transverse position can also ensue, wherein now eight feed positions would have to be taken into account in the position orientation of the mail pieces instead of four.

The eight feed positions comprise the aforementioned four feed positions according to FIGS. 2-I, 2-II, 2-III, 2-IV for mail pieces in the longitudinal orientation as well as four additional feed positions for mail pieces in transverse orientation. The transverse orientation proceeds from the longitudinal position when the mail pieces are respectively rotated to the left at an angle of +9°.

However, the cost-conscious operator will normally choose a cost-effective opening width of the depositing slot of the closure of the feed channel and thus select the longitudinal orientation in the feeding of a mail piece.

FIGS. 4b-I, 4b-II, 4b-III, 4b-IV show a plan view of a device 6 (shown simplified) for positionally accurate alignment of mail pieces that lie on an x/y plane. The mail pieces have been supplied standing on edge in different feed positions of the mail piece acceptance device. The aforementioned device 6 was shown simplified as a circle with four quarters Q1, Q2, Q3, Q4. As a result of the evaluation of the scanning results by a controller, the aforementioned device 6 (controlled by said controller) implements the required movements for positionally accurate alignment of mail pieces in the following manner:

A mail piece supplied in the first feed position I is transferred via a first movement A1 into the shown side position and is positioned in the third and fourth quarter Q3, Q4 of the device 6, and subsequently is brought into a storage position (shown in FIG. 4c-I/III) in the first and fourth quarter Q1, Q4 via a first rotation B1.

A mail piece supplied in the second feed position II is transferred via a second movement A2 into the shown side position and is positioned in the first and second quarter Q1, Q2 of the device 6, and subsequently is brought into a storage position (shown in FIG. 4c-II/IV) in the second and third quarter Q2, Q3 by a second rotation B2.

A mail piece supplied in the third feed position III is transferred via a second movement A2 into the shown side position and is positioned in the first and second quarter of the device 6, and subsequently is brought into a storage position (shown in FIG. 4c-I/III) in the first and fourth quarter Q1, Q4 by a third rotation B3.\

A mail piece supplied in the second feed position IV is transferred via a first movement A1 into the shown side position and is positioned in the third and fourth quarter Q3, Q4 of the device 6, and subsequently is brought into a storage position (shown in FIG. 4c-II/IV) in the second and third quarter Q2, Q3 by a fourth rotation B4.

It is provided that the first an second movement are folding or pivoting movements which are executed by the fourth device 6 itself. The folding or pivoting movements respectively ensue around a rotation axis at an angle of approximately 90°, for example, wherein the aforementioned rotation axis lies parallel to the x-axis.

Alternatively, it is provided that the first and second movement of the mail pieces are feed movements which are executed by a separate device (not shown) in order to supply a mail piece to a rotating plate. For example, after traversing a deflector a mail piece can be brought onto a sliding track which runs in space so that the mail piece arrives in a side position in the suitable position on a rotating plate of the fourth device 6.

FIGS. 4c-I/III, 4c-II/IV show a plan view of a device 6 (shown simplified) for positionally accurate alignment before and after output of the mail piece in the output position and upon printing during the transport of the mail piece in the y-direction.

FIGS. 4c-I/III show a first dispensing position of a mail piece in a first and fourth quarter Q1, Q4 of a rotating plate 60 before output of the mail piece in the output position 2b. The output ensues by means of a first output movement C1 in the x-direction.

FIGS. 4c-II/IV show a second dispensing position of a mail piece in a second and third quarter Q2, Q3 of the rotating plate 60 before output of the mail piece in the output position 2b. The output ensues by means of a second output movement C2 in the same x-direction, wherein a second distance covered by the mail piece during the second output movement C2 is longer than a first distance covered during the first output movement C1.

The mail pieces lie on their back sides in the dispensing and output position and are all aligned with the same orientation for a further transport.

From FIGS. 4c-I/III, 4c-II/IV it is apparent that the aforementioned transport direction of the mail piece now ensues in the y-direction, i.e. has been changed by an angle of +90° relative to the x-direction during the feed. The mail piece 2c printed by the printer 8 subsequently arrives at the storage.

Alternatively, a direction change for the transport direction of the mail piece can occur in an angle range from 0° to +90° after output of the mail piece in an output position.

In principle, it is also possible that the aforementioned transport direction of the mail piece ensues in the direction opposite the y-direction or in an angle range from 0° to −90°.

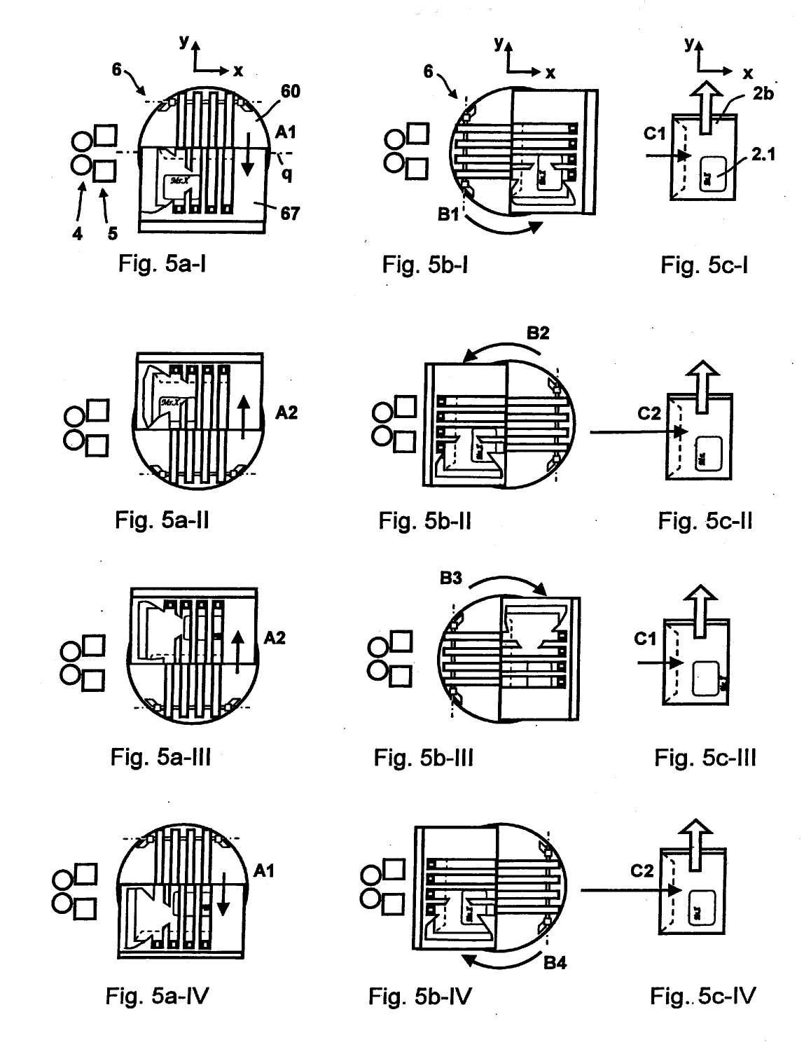

FIGS. 5a-I, 5a-II, 5a-III, 5a-IV show a simplified representation of the plan view of the rotating plate 60 with pivot device 67 after a quarter rotation of the pivot device on an axis q parallel to the x-direction. The mail piece respectively lies on the back side within the pivot device. The latter was shown in section to clarify the mail piece orientation. The movements of the pivot device are clarified with arrows A1 and A2. The rotating plate 60 with pivot device 67 is a component of the fourth device 6 for automatic position orientation and position alignment which a mail piece achieves after passing through the second device 4 for drawing mail pieces into the feed channel and the third device 5 for orientation scanning of a mail piece in the feed channel. FIGS. 5a-I, 5a-II, 5a-III, 5a-IV show only one of the possible embodiments of the fourth device 6. They clarify the implementation of a first group A{n} with n=1, 2 movement types of the movements already explained using FIGS. 4b-I, 4b-II, 4b-III, 4b-IV.

FIGS. 5b-I, 5b-II, 5b-III, 5b-IV show a simplified representation of the plan view of the rotating plate with pivot device after a quarter rotation of the rotating plate on an axis (not shown) parallel to the z-direction that is orthogonal to the x/y surface. The movements were respectively represented with arrows B1, B2, B3 and B4.

The movements were respectively shown with arrows B1, B2, B3 and A4. FIGS. 5b-I, 5b-II, 5b-III, 5b-IV show a possible embodiment for the implementation of a second group B{n} with n=1, 2, 3, 4 rotation movements by means of rotating plate, corresponding to the movements already explained using FIGS. 4b-I, 4b-II, 4b-III, 4b-IV.

FIGS. 5c-I, 5c-II, 5c-III, 5c-IV show a plan view of a mail piece 2b in the output position after a respective movement (black arrow) from the group B, corresponding to the movements C1 and C2 already explained using FIGS. 4c-I/III and 4c-II/IV, respectively and before a movement (white arrow) of the mail piece in the transport direction (y-direction). The shown address field 2.1 indicates the flat position of the mail piece.

FIG. 6a shows a plan view of a device 6 for positionally accurate alignment of mail pieces, with a rotating plate 60 and with a pivot device 67 in the feed phase of a mail piece in the first feed position I. The mail piece 2a-I, standing on edge in the x-direction, traverses the second device 4 for drawing mail pieces into the feed channel and third device 5 for orientation scanning of a mail piece before reaching the fourth device 6. A number of transport means 61, 62, 63, 64 transversal to the x-direction and orthogonal to the x/y plane (i.e. in the z-direction) are arranged on the rotating plate 60 of the fourth device 6. The pivot device 67 is arranged over the transport devices 61, 62, 63, 64 and is fashioned to catch mail pieces standing on edge in the feed phase. It is attached to a shaft 651 which lies on a rotation axis q parallel to the x-direction.

FIG. 6b shows a side view of the feed channel 13 and of the pivot device 67 of the fourth device 6. The feed channel 13 is designed like a drawer and consists of at least one slot plate 13.1, two side walls 13.2, 13.4 and a rear wall 13.3. Moreover, it is equipped (not shown) with sensors or photoelectric barriers, transport means and retention means to hold the mail piece until the point in time at which it leaves the feed channel 13. The mail piece 2 is drawn protruding from the bottom of the feed channel 13 at the point in time of leaving the feed channel 13, for example due solely to the force of gravity. The pivot device 67 is arranged on the rotating plate 60, which is centrally mounted on a shaft 681 through whose center a rotation axis r runs parallel to the z-direction.

FIG. 6c shows a front view of the device 6 for positionally accurate alignment of mail pieces in the y/z-plane, with a rotating plate 60 and with a pivot device 67 in the feed phase of a mail piece 2a-I in the feed position I after the point in time of leaving the feed channel. The pivot device 67 is rotated so that one of the openings points upward in the z-direction an also has a corresponding opening width for a mail piece with maximum thickness (50 mm). A third motor 66 (for example a direct current motor M3) with a shaft 66a to drive the transport devices 61, 62, 63, 64 (for example via a drive belt) is arranged at the edge of the rotating plate 60. The transport device 61 has a driven roller 611 and an undriven roller 612 for a transport belt 614. The driven roller 611 and the undriven roller 612, borne in bearings (FIG. 6d), can be respectively rotated on a shaft 615, 616 above the rotating plate 60. The bearings are spaced from the surface of the rotating plate 60 by means of distancing spacers 601, 602. A fourth motor 68 (for example a step motor M4) whose shaft 681 is centrally positively and non-positively connected with the underside of the rotating plate 60 is arranged below the rotating plate. The pivot device 67 is attached on a shaft 651 which is centrally arranged in a region between the rollers 611, 612 parallel to their drive shafts 615, 616 and is borne such that it can rotate in the x-direction. The pivot device 67 can be pivoted in the clockwise direction A1 or opposite to this in the direction A2.

The pivot device 67 consists of a rectangular frame that folds in a V-shape in the middle and is attached on the shaft 651, for example by spot welds. The V-shaped, folded sub-region of the frame extends from half of to the entire length, which corresponds to the size of the diameter of the driven roller 611 of the first transport device 61. The sub-regions of the frame in which both opposing halves of the frame run parallel to one another connect to the V-shaped, folded sub-region of the frame. The frame folded in this way has a rectangular opening whose dimensions are determined by the dimensions of the largest mail pieces to be carried. The rectangular opening is open on four sides (i.e. forward and back as well as up and down in the shown position) for a mail piece and is bounded by side walls.

FIG. 6d shows a side view of the pivot device 67 in the x/z-plane. The plate 671 and an opposite plate (covered) are externally centrally mounted as side walls 671 between the edges of the frame 670 (in the region of the V-shaped fold and the shaft 651), both of which plates are centrally provided with slot-shaped openings 6711, 6712, 6713, 6714 in the region opposite the transport means 61, 62, 63, 64. The shaft 651 can be directly or indirectly mechanically coupled with a fifth motor 65 (for example a direct current motor M5) which is arranged and attached to the rotating plate 60 in the shown position or in another position. The plate 671 arrives below the top side of the transport belts when the fifth motor 65 is activated and the pivot device 67 is pivoted. The rotation axis q which is situated parallel to the x-axis runs coaxial with the shaft 651. The shaft 651 is borne such that it can rotate in opposite bearings 691, 692 at the edge of the rotating plate 60. The transport means 61, 62, 63, 64 possess driven rollers which are attached on a shaft 615 through which a rotation axis (not shown) runs which is likewise parallel to the x-axis. The shaft 615 is driven by the third motor 66 via the drive belt 613 which, for example, is fashioned as a toothed belt. Matching toothed rollers (not shown) that engage with the teeth of the toothed belt are then correspondingly arranged on the shaft 615 and the motor shaft 661 of the third motor 66. The actuation can also alternatively ensue in a different manner, for example by means of drive chain and gearwheels. The controller (not shown) is electrically connected with the motors and programmed to correspondingly activate the actuators. The fourth device 6 for automatic position alignment of a mail piece possesses at least one actuator which is activated by the controller 10 in order to transfer the mail piece from an (arbitrary) feed position 2a before output of the mail piece into a predetermined output position 2b, wherein all mail pieces lie in the supine position and are all oriented the same for a further transport.

Alternatively, other means than the plate 671 and an opposing plate (covered) can be mounted as side walls, for example wire fences or wire brackets suitably shaped to hold mail pieces.

FIG. 6e shows a front view of the device 6 for positionally accurate alignment of mail pieces in the y/z-plane, i.e. in a phase after the pivoting of a mail piece 2. The plate 671 and the shaft 651 lie below and the plate 672 lies above the top of the transport belts.

FIG. 6f shows a side view of the device for positionally accurate alignment of mail pieces in the x/z-plane after a quarter rotation of the pivot device on an axis parallel to the z-direction. The slot in the plate 671 is wide enough that the function of the transport device 61 (namely the transport of the mail piece) is not hindered.

FIG. 6g shows a side view of a mail piece in the output position upon transport in the x-direction from the pivot device. The mail piece 2b lies on its back, which can be detected at the envelope flap 2.3.

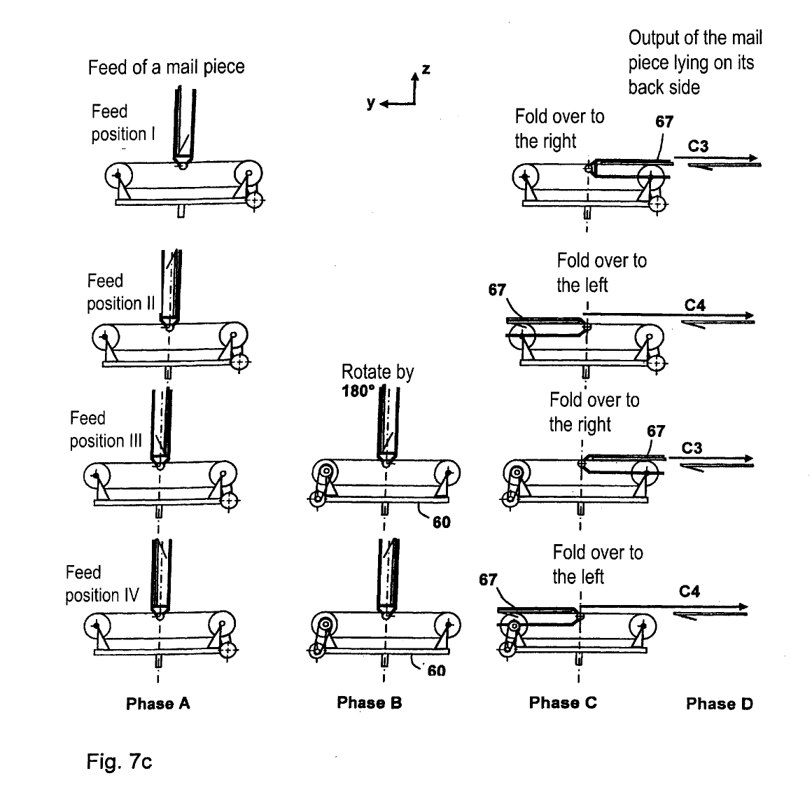

FIG. 7a shows a perspective representation of a second variant of a mail piece acceptance device 1 from the front top right. A user interface 12′, a mail piece depositing slot plate 13.1′, a receipt output device 18′, a flap 17.1′ of a mail piece return bin to return unprocessed mail pieces to the operator (postal customer), and possibly an access 9.0′ to the waste container are arranged on the front side near the right side of a card reader cover plate 11′. Moreover, additional—not visible—side accesses to the storage containers exist.

FIG. 7b shows a simplified representation of a plan view of the rotating plate 60′ with mail piece in the transport path for transport in the x-direction and for printing according to a second variant of the mail piece acceptance device. The output of the mail piece in the output position 2b′ ensues by means of a third motor 66′ of the mail piece acceptance device (1′) that is activated by a controller 10′ to output the mail piece opposite to the y-direction by means of a third or fourth output movement C3 or C4, wherein a fourth distance traveled by the mail piece during the fourth output movement C4 is longer than a third distance covered during the third output movement C3.

After the rotation the mail piece 2b maintains a flat position in relation to the standing position upon being fed into the third device with the scanners 5a′, 5b′ for orientation scanning of a mail piece in the feed channel. This maintained position of the mail piece 2c′ (FIG. 7b) is rotated on an axis parallel to the z-direction by an angle of −90° in the clockwise direction relative to that of the mail piece 2c according to FIG. 4c-I/III. The programming of the controller 10′ to control the fourth device 6′ is correspondingly adapted. The rotation of the rotating plate can also ensue before a pivoting or, respectively, folding down of the mail pieces, as is subsequently explained using FIG. 7c.

FIG. 7c shows a front view of the rotating plate with pivot device in the y/z-plane and a mail piece in phases that processed in the mail piece acceptance device 1′ of the second variant. For example, the mail piece is a letter in an envelope with address field. The longitudinal edge lies on the fold edge of the envelope flap of the envelope or precisely opposite, near the address window (not shown).

Phase A clarifies four feed positions of a mail piece supplied standing on the longitudinal edge. The following cases are to be noted:
a) In the first feed position I and third feed position III, the mail piece or, respectively, enveloped letter stands on that longitudinal edge which is situated on the fold edge of the envelope flap. The envelope flap sticks out from the envelope, in fact sticks out in the direction opposite the y-direction.
   In contrast to the first feed position I, however, the envelope flap of the letter envelope supplied in the third feed position III sticks out in the y-direction at the envelope of the letter (mail piece).
b) In the second feed position II and fourth feed position IV, the mail piece or, respectively, enveloped letter stands on that longitudinal edge which is situated opposite the fold edge of the envelope flap. The envelope flap sticks out from the envelope, in fact sticks out in the y-direction.
   In contrast to the second feed position II, however, the envelope flap of the letter envelope supplied in the fourth feed position IV sticks out in the direction opposite the y-direction at the envelope of the letter (mail piece).

For two of four feed positions of a mail piece supplied standing on the longitudinal edge, the phase B clarifies that no rotation must occur. This is the aforementioned case a).

For the two other of the four feed positions of a mail piece, the phase B moreover clarifies that a rotation on an axis parallel to the z-direction by an angle of 180° must occur by means of the rotating plate 60. This is the aforementioned case b).

For the mail piece supplied standing in different feed positions on the longitudinal edge, the phase C that the mail piece must be folded down by means of the pivot device. The following cases are to be noted:
c) given a mail piece supplied in the first position I and third position III, a folding down of the mail piece to the right occurs, i.e. in the direction opposite to the y-direction

and
d) given a mail piece supplied in the second position II and fourth position IV, a folding down of the mail piece to the left occurs, i.e. in the y-direction.

Given a mail piece supplied in the first feed position I and the third feed position III, the mail piece leaves the pivot device via the same opening through which the mail piece was supplied to the pivot device.

Given a mail supplied in the second feed position II and the fourth feed position IV, the mail piece exits the pivot device through the opposite opening, i.e., not through the same opening through which the mail piece was supplied to the pivot device.

Phase D explains the depositing of the mail piece resting on its backside. Given a mail piece supplied in the first feed position I and third feed position III, the mail piece leaves the pivot device with a third movement C3 on a short path. Given a mail piece supplied in the second feed position II and fourth feed position IV, the mail piece leaves the pivot device with a fourth movement C4 on a longer path in comparison to the first path, wherein both paths lead in the direction opposite the y-direction.

An implementation of the fourth movement C4 requires two opposite openings in the pivot device 67 of the device 6 for positionally accurate alignment of mail pieces, which arises from FIGS. 6a and 6b. Both openings of the pivot device 67 are shown open in the z-direction, wherein the movement (white arrow) of the mail piece ends at a rotating plate 60.

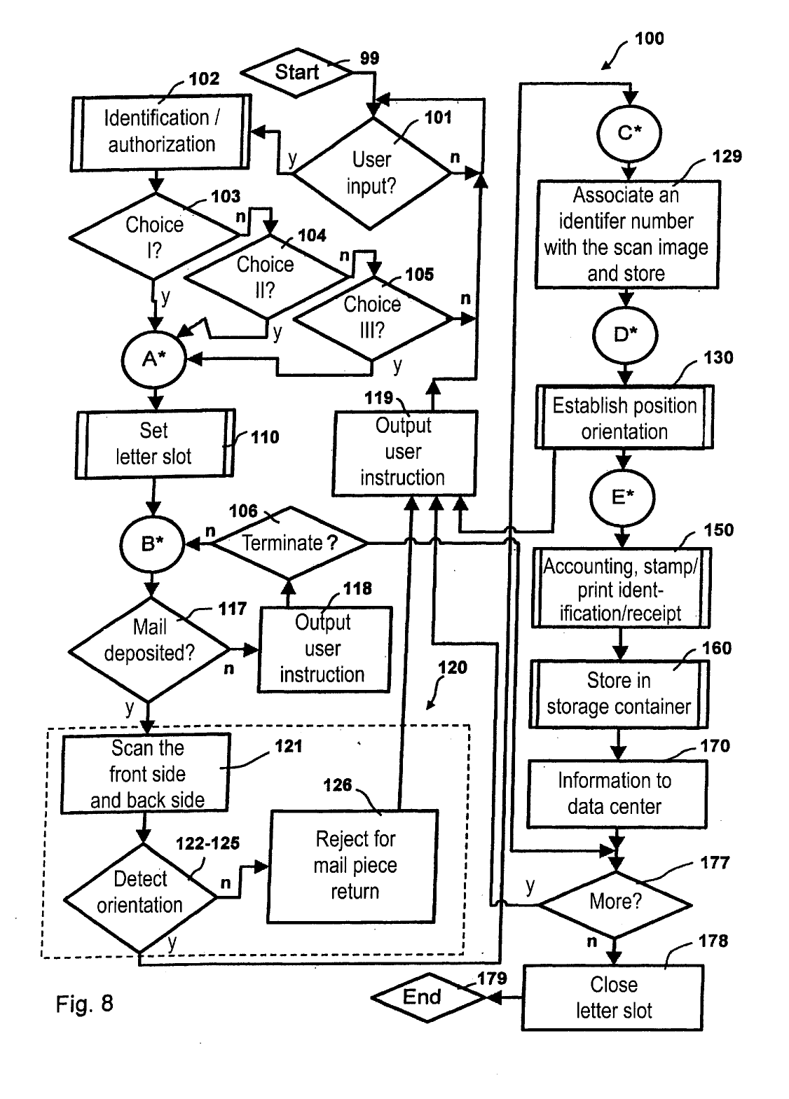

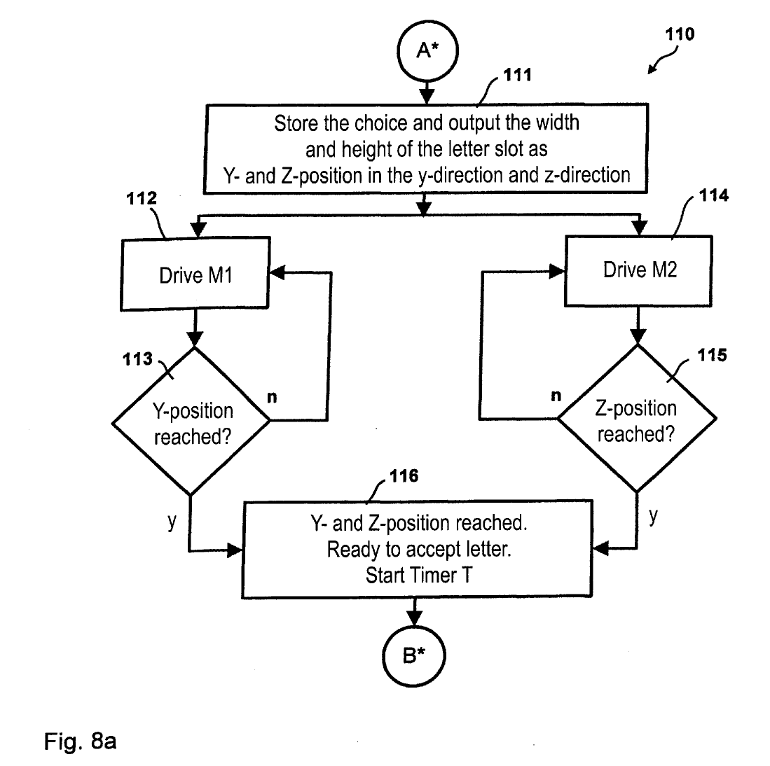

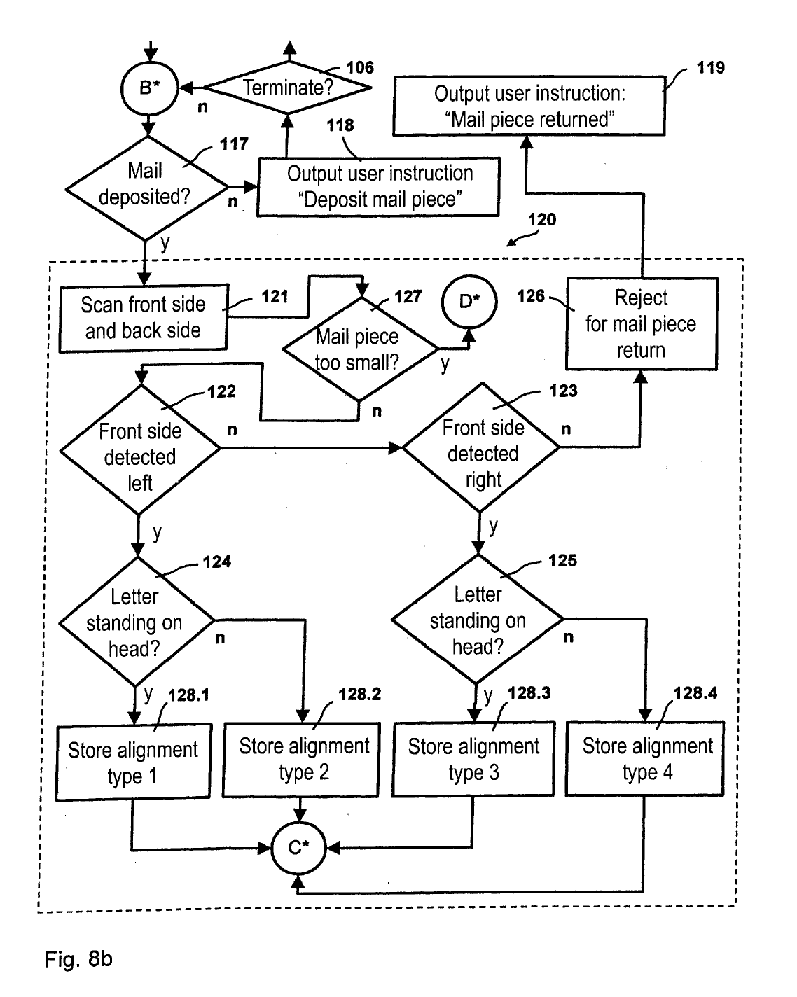

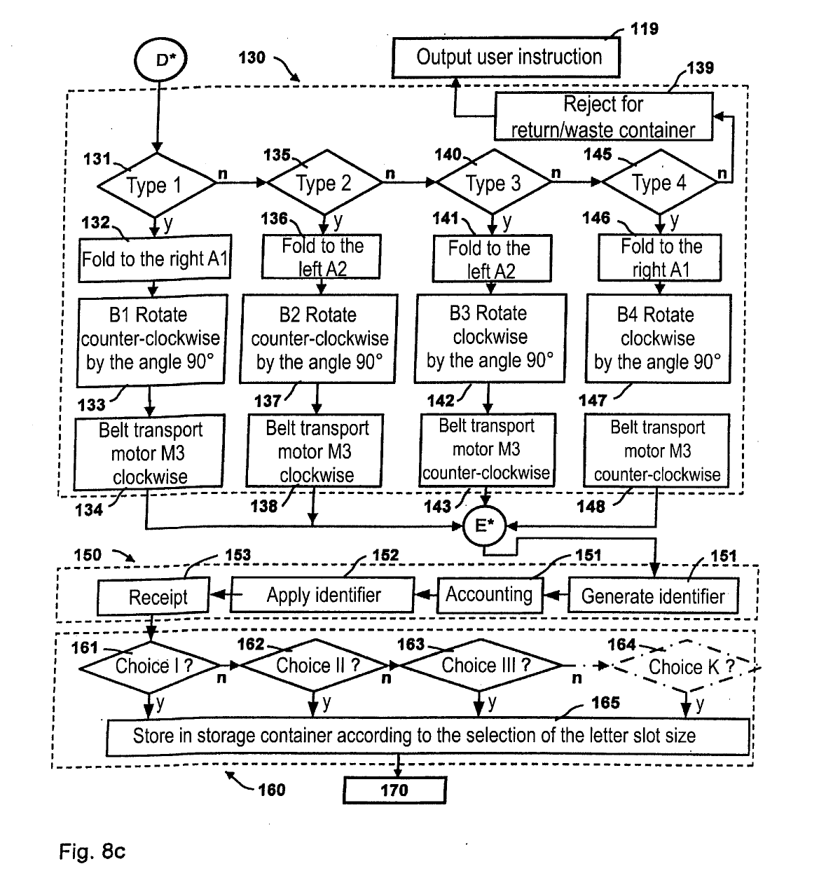

A flowchart for an embodiment of the operation of the mail piece acceptance device is shown using FIG. 8. After activating the mail piece acceptance device, a Start Step 99 is reached. The workflow plan 100 includes the following steps after the Start Step 99:
a query for a user input or, respectively, user action in the Query Step 101, wherein a wait loop branches back to the input of the Query Step 101 if no user input or, respectively, user action can be established,
an identification/authorization of the user/the user input in the step 102 via a postal security device (PSD) of the mail piece acceptance device,
a selection of multiple possibilities and after this a determination of the pre-selection of the letter slot size in the Query Step 103, Query Step 104 or Query Step 105 with subsequent arrival at a first point (A*) in the workflow plan 100, or a non-determination of the pre-selection with subsequently branching back to the beginning of the Query Step 101,
an implementation of a sub-program to set the slot size in the step 110 with subsequent arrival at a second point (B*) in the workflow plan 100,
a query for a mail piece depositing in the following Query Step 117 and
an output of a user instruction with a request for the user to deposit a mail piece in the step 118 if a mail piece deposit has not yet been established or
an implementation of a sub-program to detect the orientation of the deposited mail piece in the step 120 when a mail piece deposit is established, and subsequent arrival at a third point (C*) in the flowchart 100, wherein in the aforementioned sub-program a scanning of the front side and back side of the mail piece ensues in a sub-step 121 and Query sub-Steps 122 through 125 to detect the orientation of the deposited mail piece before arriving at point (C*) in the flowchart 100 in which cases are run through in which the front side or back side of the deposited mail piece was detected; and wherein otherwise, via a sub-step 126, with rejection of the mail piece in the mail piece acceptance device to the mail piece return the workflow branches back to a step 119 to output a user instruction in order to request the user take back the deposited mail piece, and wherein the workflow branches back to the beginning of the Query Step 101 after the step 119,
a generation of an identifier number after reaching the third point C* in the step 129 of the workflow plan 100, wherein the identifier number is respectively associated with a scanned image of the front side and back side of the deposited mail piece and is stored before a fourth point (D*) in the flowchart 100 is reached,
an implementation of a sub-program to establish a predetermined position orientation of the deposited mail piece in the step 130 of the workflow plan 100 after reaching the fourth point (D*) and before reaching a fifth point (E*) in the flowchart 100,
a generation of an identifier for the mail piece, billing, accounting and application of a marking on the mail piece, and possibly printout of a receipt in the step 150 after reaching the fifth point (E*) in the workflow plan 100,
an implementation of a sub-program to store the deposited mail piece in the step 160, wherein the respective storage container is selected corresponding to the pre-selection and
information pertaining to the mail piece, the associated identifier number and the identifier printed on the mail piece (which identifier is respectively associated with a scanned image of the front side and back side of the deposited mail piece) is stored at a data center in the step 170 before a Query Step 177 is executed in order to establish whether the user still needs to deposit additional mail pieces at the mail piece acceptance device; wherein, when the latter case occurs, the workflow branches back from the Query Step 177 to the step 119 for output of a user instruction before additional inputs made by the user are registered and/or an additional mail piece is deposited by the same user,
otherwise, when the latter case is not desired, an additional mail piece is deposited by the same user and no further input is made within a predetermined time period, the workflow branches back to step 178 to close the letter slot, wherein an End Step 179 to end the flowchart 100 is reached upon closing.

The pre-selection made by the user to adjust the deposit opening of the mail piece acceptance device is queried by the workflow steps 103, 104 and 105 and can be expanded with additional Query Steps if this should be required due to changed postal rules or, respectively, different country-dependent or authority-dependent postal rules. It thereby applies that the workflow branches to the second pre-selection II if the first pre-selection I was not detected as having been selected. If the second pre-selection II is detected as not having been selected, the workflow branches to the third pre-selection III etc. until the querying of a K-th pre-selection. If the latter is not detected as having been chosen, the workflow branches back to the beginning of the first workflow step 101.

FIG. 8a shows a sub-program 110 to adjust the deposit opening of the mail piece acceptance device which runs after reaching the first point (A*) in the workflow plan 100. A storage of the pre-selection of the deposit opening (letter slot size) made by the user and output of the width and height of the desired deposit opening in the form of parameters (which identify the Y- and Z-position) ensue in a first sub-step 111. The corresponding Y- and Z-position is reached when the closure jaws are moved in the y-direction and z-direction in order to set the opening width of the closure of the feed channel for mail pieces. The sub-program to set the slot size in the third step (110) includes a second sub-step (112) to control a second motor M1 and a fourth sub-step (114) to control a second motor M2, wherein in the respective following third and fifth Query sub-Steps (113 and 115) it is checked whether the Y-position and the Z-position have already been reached, and wherein otherwise the first motor M1 and the second motor M2 for jaw adjustment are additionally activated.

Otherwise, after it has been established in the Query sub-Steps 113 and 115 that the Y-position and the Z-position have already been reached, a timer of the controller 10 is started in a sixth sub-step 116, which timer runs until a preset time/numerical value is reached. The latter determines how long a readiness of the mail piece acceptance device to accept letters should last. An arrival at the preset time/numerical value by the timer is monitored in step 106 of the flowchart 100. The timer is reset (not shown) when the workflow branches back via additional steps to the Query Step 101. The second point (B*) in the workflow plan 100 is reached after setting the opening width of the closure (slot size) in the sub-program 110.

FIG. 8b shows a sub-program 120 to scan the front side and back side of a mail piece and for orientation detection of a mail piece in the mail piece acceptance device. After the second point (B*) of the flowchart 100, a mail piece deposit is queried in the Query Step 117 and the workflow branches to the first sub-step 121 of the sub-program 120 when a mail piece deposit in the opening (the letter slot) of the closure of the feed channel has occurred, which is detected by corresponding sensors in the feed channel. Otherwise, if no mail piece deposit was detected in Query Step 117, the workflow branches back to point (B) via step 118 for the output of a user instruction (“Deposit mail piece”) and via the Query Step 106. In the first sub-step 121 of the sub-program 120, a scanning of the front side and back side of the mail piece and an evaluation of the scan data occur.

Based on the evaluation of the scan data, in a Query sub-Step 127 it can subsequently be decided whether the mail piece is too small. The latter is the case if a mail piece falls short of the minimum dimensions that are provided by the postal carrier. The workflow then branches to the fourth point (D*). Otherwise, the workflow branches from the Query sub-Step 127 to a Query sub-Step 122 to check whether the front side was detected by a scanning device arranged to the left of the feed channel for mail pieces. If this is not the case, the workflow branches to Query sub-Step 123 to check whether the front side was detected by a scanning device arranged to the right of the feed channel for mail pieces. If this is likewise not the case, the workflow branches via a sub-step 126 to reject the mail piece for its return via the bin 17 (FIG. 1b) to the nineteenth step 119 of the workflow plan 100 in order to display a user instruction “Mail piece returned”.

The workflow branches from the Query sub-Step 122 to a fourth Query sub-Step 124 when the front side has been detected by a scanning device arranged to the left of the feed channel for mail pieces.

The workflow branches from the Query sub-Step 123 to a Query sub-Step 125 when the front side has been detected by a scanning device arranged to the right of the feed channel for mail pieces.

In the Query sub-Step 124 it is subsequently established whether a mail piece is standing on its head because it was supplied on the edge with the envelope flap, and then the workflow branches to a first memory sub-step 128.1 in order to store a first type 1 of the alignment of the mail pieces corresponding to a first feed position; wherein otherwise, if a mail piece is not standing on its head, the workflow branches from the Query sub-Step 124 to a second memory sub-step 128.2 in order to store a type 2 of the alignment of the mail pieces corresponding to a second feed position II.

If a mail piece is standing on its shorter side, i.e. if it was supplied standing on the edge with the envelope flap, the workflow then branches from the Query sub-Step 125 to a third memory sub-step 128.3 in order to store a third type 3 of the alignment of the mail pieces corresponding to the third feed position III. Otherwise, if a mail piece is not standing on its shorter side, the workflow branches from the Query sub-Step 125 to a memory sub-step 128.4 in order to store a fourth type 4 of the alignment of the mail pieces corresponding to the fourth feed position IV. The third point (C*) is reached after storing the type in the first, second, third or memory sub-step.

The third device for scanning the mail piece surface is operationally connected with the controller which on the one hand contains (stored in a non-volatile manner in a memory) the sub-program for scanning and evaluation of the scanned data and on the other hand contains a sub-program for position orientation, which sub-programs a microprocessor of the controller accesses during the operation as soon as a scan result is present.

FIG. 8c shows sub-programs for position alignment of a mail piece in the mail piece acceptance device; for generation of an identifier or, respectively, billing number; for billing of the mail piece shipping job; for accounting of the carriage feel for printing the marking (identifier); possibly for printing a receipt; and for storage in a storage container. A sub-program 130 is provided for position alignment of a mail piece in the mail piece acceptance device, and sub-program 160 is provided for storage in a storage container. A sub-program 150 with a first sub-program 151 for generation of an identifier or, respectively, billing number and with a second sub-program 152 for billing the mail piece shipping job and accounting is present between the aforementioned two sub-programs 130 and 160, wherein the sub-programs are executed by the processor of the postal security device. A sub-program 153 for printing the identifier or billing number, a sub-program 154 for printout of a receipt and the aforementioned sub-program 160 for storage in a storage container follow, wherein these sub-programs are likewise executed by the processor of the mainboard of the controller 10. The latter should not be discussed in detail here because the transport of a mail piece with printing of the marking, receipt printing and storage are known to the man skilled in the art.

The sub-program 130 for position alignment begins after reaching the fourth point (D*) with a query after the first Query sub-Step 131 as to the first type 1 of the alignment of the mail pieces. If a type 1 exists, a sub-step 132 is reached, wherein the controller activates the motor 65 to drive the pivot device 67 (FIG. 6d) in order to fold said pivot device in the A1 direction (towards −y), i.e. to fold it to the right (FIG. 6c). After folding down the pivot device 67 to the right in the A1 direction, the state shown in FIG. 5a-I exists.

Otherwise, if no type 1 exists, the workflow branches from the first Query sub-Step 131 to a second Query sub-Step 135. There it is queried whether a second type 2 of the alignment of the mail pieces is present. If a type 2 exists, a sub-step 136 is reached, wherein the controller activates the motor 65 for driving the pivot device 67 in order to folding this in the A2 direction (toward y), i.e. to the left. After folding over the pivot device 67 to the left in the A2 direction, the state shown in FIG. 5a-II exists.

Otherwise, if neither a type 1 or a type 2 is present, the workflow branches from the second Query sub-Step 135 to the third Query sub-Step 140. There it is queried whether a third type 3 of alignment of the mail pieces is present. If a type 3 exists, a sub-step 141 is reached, wherein the controller activates the motor 65 to drive the pivot device 67 in order to fold this in the A2 direction (towards y), i.e. to the left. After folding the pivot device 67 over to the left in the A2 direction, the state shown in FIG. 5a-III exists.

Otherwise, if neither a type 1 or a type 2 or a type 3 is present, the workflow branches from the third Query sub-Step 140 to the fourth Query sub-Step 145. If a type 4 is reached, a sub-step 146 is reached, wherein the controller activates the motor 65 to drive the pivot device 67 in order to fold this in the A1 direction (towards −y), i.e. to the right. After folding the pivot device 67 over to the right in the A1 direction, the state shown in FIG. 5a-IV exists.

If no type 4 is present, a sub-step 139 is reached for rejection of the mail piece for the purpose of returning it or for storage in a waste container. The waste container can advantageously be arranged below the return bin and be separated by a screen. Small metal parts and other waste fall through the sieve while mail pieces that are too small or are unaddressed remain in the return bin. Starting from the aforementioned sub-step 129, a step 119 for the output of a corresponding user instruction to request that the user empty the return bin is reached.

If a type 1 exists, after the sub-step 132 a sub-step 133 is reached, wherein the controller activates the motor 68 to drive the rotating plate 60 (FIG. 6c) in order to rotate this by an angle of 90° in the B1 direction counter to the clockwise direction (FIG. 6f) on the axis r situated parallel to the z-direction. After the rotation of the rotating plate, the state shown in FIG. 5b-I is present.

If a type 2 is present, a sub-step 137 is reached after the sub-step 136, wherein the controller activates the motor 68 to drive the rotating plate 60 in order to rotate this by an angle of 90° in the B2 direction counter to the clockwise direction on the axis r situated parallel to the z-direction. After the rotation of the rotating plate, the state shown in FIG. 5b-II is present.

If a type 3 is present, a sub-Step 142 is reached after the sub-step 141, wherein the controller activates the motor 68 to drive the rotating plate 60 in order to rotate this by an angle of 90° in the B3 direction counter to the clockwise direction on the axis r situated parallel to the z-direction. After the rotation of the rotating plate, the state shown in FIG. 5b-III is present.

If a type 4 is present, a sub-step 147 is reached after the sub-step 146, wherein the controller activates the motor 68 to drive the rotating plate 60 in order to rotate this by an angle of 90° in the B4 direction counter to the clockwise direction on the axis r situated parallel to the z-direction. After the rotation of the rotating plate, the state shown in FIG. 5b-IV is present.

Following the sub-steps 133, 137, 142 and 147 to drive the rotating plate, a belt transport ensues in the sub-steps 134, 138, 143 and 148 to move the mail piece away from the rotating plate before a fifth point (E*) is reached. For belt transport in the sub-steps 134 and 138, the motor 66 is activated by the controller in order to rotate a shaft 615 (shown in FIG. 6d) in the clockwise direction, i.e. the shaft and therefore also the transport belts 61, 62, 63, 64 (shown in FIG. 6a) are brought to clockwise rotation. For belt transport in the sub-steps 143 and 148, the motor 66 is activated by the controller in order to rotate a shaft 615 (shown in FIG. 6d) counter to the clockwise direction, i.e. the shaft and therefore also the transport belts 61, 62, 63, 64 (shown in FIG. 6a) are brought to counter-clockwise rotation.

After the sub-program 130 for positional alignment, the sub-program 150 follows in whose first sub-sub-program 151 an individual identifier is generated for the mail piece by the PSD of the controller; in whose second sub-sub-program 152 the accounting ensues; in whose third sub-sub-program 153 the transport of the mail piece by the sixth transport device is started and an identifier is printed on the mail piece by means of the printer of the fifth device; and in whose fourth sub-sub-program 154 a receipt printer is activated in order to print out a receipt to verify the carriage job for the user, i.e. postal customer.

After the sub-program 150, the sub-program 160 follows for storing the deposited mail piece in the storage container, which sub-program 160 possesses Query sub-Steps 161, 162, 163, 164 so that—depending on the pre-selection of the size of the set opening width—a storage in the storage container ensues in a subsequent sub-step 166 upon matching the query condition. In the sub-program 160 for storage in the storage container, the pre-selection made by the user is queried in Query sub-Steps 161, 162, 163, and optionally as needed in at least one addition Query sub-Step 164 (shown with a dash-dot line). It thereby applies that the workflow branches to the respective following query of the pre-selection K if the immediately preceding query of the pre-selection K−1 was not registered as having been stored. Depending on the pre-selection, an activation of deflectors for the corresponding storage ensues in the respective following sub-step of a step 165 for storage in the storage container.

Although modifications and changes may be suggested by those skilled in the art, it is the intention of the inventor to embody within the patent warranted hereon all changes and modifications as reasonably and properly come within the scope of his contribution to the art.

I claim as my invention:

1. A mail acceptance device comprising:
a housing;
a mail item feed structure having an adjustable opening at an exterior of said housing that communicates with a feed path of said feed structure, said adjustable opening being adjustable in size to allow respective mail items of different sizes to be fed through said feed shaft of said mail item feed structure into an interior of said housing, said mail item feed structure comprising a controller that interacts with said adjustable opening to mechanically change the size of said adjustable opening;
a computer in said housing having a user interface accessible from an exterior of said housing, said computer being connected to said controller and said user interface and said computer being configured to allow a user to enter information into said computer describing a mail item to be inserted into said mail item feed structure and to automatically operate said controller to set a size of said adjustable opening dependent on said information;
an accounting unit in said housing having a card reader connected thereto, said card reader being configured to receive a card encoded with information associated with said user, and said accounting unit being configured to automatically charge a postage fee to said user for mailing said mail item using a mail carrier;
a plurality of secure storage containers in said housing;
a transport path in said housing between said feed shaft of said mail item feed structure and said secure storage containers;
a scanner disposed in said transport path in said housing that automatically scans a surface of said mail item while in said transport path to detect information on said surface of said mail item that is relevant to said mailing of said mail item by said carrier;
a position alignment unit in said transport path that automatically orients said mail item into a predetermined orientation of the mail item in said transport path;
a printer in communication with said scanner that prints a marking on said mail item in said transport path, dependent on said information detected by said scanner, that permits tracking said mailing of said mail item; and
a transport unit in said transport path that transports said mail item along said transport path and that diverts said mail item in said transport path to said one of said secure storage containers dependent on the size of said mail piece represented by said information entered by the user.

2. A mail item acceptance device as claimed in claim 1 wherein said scanning unit comprises an OCR unit.

3. A mail item acceptance device as claimed in claim 1 wherein said accounting unit is embodied in said computer.

4. A mail item acceptance device as claimed in claim 3 wherein said accounting unit is a postal security device.

5. A mail item acceptance device as claimed in claim 1 wherein said mail item feed structure comprises a first mechanism operated by said controller to adjust a width of said adjustable opening, and a second mechanism operated by said controller to draw said mail item through said adjustable opening into said feed shaft.

6. A mail item acceptance device as claimed in claim 5 wherein said mail item feed structure comprises a cover plate over said opening having a cover plate opening with fixed dimensions that are maximum allowable dimensions for a mail item established by said mail carrier, and wherein said first mechanism comprises a sensor that detects insertion of said mail item in said adjustable opening and emits a signal that is supplied to said second mechanism that actuates operation of said second mechanism to draw said mail item into said feed shaft.

7. A mail item acceptance device as claimed in claim 5 wherein said adjustable opening is formed by a first closure jaw that is movable by a first movement-imparting device and a second closure jaw that is movable by a second movement-imparting device, said first and second movement-imparting devices being controlled by said controller to adjust said size of said adjustable opening.

8. A mail item acceptance device as claimed in claim 7 wherein each of said first and second movement-imparting devices is a device selected from the group consisting of motors, electromagnetic actuators, magnets, linear motors, and pneumatically operated actuators.

9. A mail item acceptance device as claimed in claim 2 wherein said adjustable opening has a quadratic shape and comprises two immediately adjoining immediately adjoining immobile sides, and to immediately adjoining movable sides that are movable by said first mechanism.

10. A mail item acceptance device as claimed in claim 1 wherein said adjustable opening causes each mail item to be fed to said transport path on edge in an initial feed position, from among a plurality of different initial feed positions, and wherein said controller is configured to determine said initial feed position of each mail item in said transport path from an output of said scanner.

11. A mail item acceptance device as claimed in claim 10 wherein said position alignment unit comprises at least one alignment drive unit activated by said controller to reorient each mail item from said initial feed position to a predetermined output position wherein said mail item lies flat on said transport path, to cause all mail items to be in said predetermined output position at an end of said transport path.

12. A mail item acceptance device as claimed in claim 11 wherein said at least position drive unit comprises a pivoting device that captures a mail item standing on edge in said initial feed position, said pivoting device imparting a pivoting movement to said mail item around a rotation axis.

13. A mail item acceptance device as claimed in claim 12 wherein said at least one alignment drive unit comprises a rotating plate configured to accept said mail item to flip said mail item.

14. A mail item acceptance device as claimed in claim 13 wherein said pivoting device is located on said rotating plate.

15. A mail item acceptance device as claimed in claim 14 wherein said at least one alignment drive unit comprises a plurality of driven rollers that transport said mail item along said transport path.

16. A mail item acceptance device as claimed in claim 11 comprising a feed channel forming a bin with at least one slip plate and sidewalls and a rear wall.

17. A mail item acceptance device as claimed in claim 16 wherein said feed channel comprises a sensor that holds a mail item therein until said mail item exits said feed channel due to gravity.

18. A mail item acceptance device wherein said at least one alignment drive unit comprises a motor operated by said controller to move said mail item through a first output movement or a second output movement in a transport direction along said transport path, to cause said mail item to travel a second distance during said second output movement that is longer than a first distance during said first output movement.

19. A mail item acceptance device as claimed in claim 18 wherein said motor is operated by said controller to impart a third or fourth output movement, in a different direction from said transport direction, to said mail item, to cause said mail item to travel a fourth distance during said fourth output movement that is longer than a third distance travel during said third output movement.

20. A mail item acceptance device wherein said accounting unit comprises a receipt output device that prints a receipt for said postage fee and that makes said receipt accessible from an exterior of said housing.

21. A mail item acceptance device as claimed in claim 20 comprising an access opening in said housing and a waste container in communication with said access.

22. A mail item acceptance device as claimed in claim 20 comprising a normally closed access opening in said housing allowing access to said storage containers at a front of said housing.

23. A mail item acceptance device as claimed in claim 20 comprising a normally closed access opening in said housing allowing access to said storage containers at a side of said housing.

24. A method for mail piece acceptance with checking of the authorization of the operator for usage by means of an authorization card or postage credit card, wherein a storage in secured storage containers in the storage region ensues after settling the postage fee via a billing unit, comprising the steps of:
identifying the customer number authorization for operation of the mail piece acceptance device;
determining the pre-selection made by the operator and setting of the opening width of the depositing slit of the closure of the feed channel of the mail piece acceptance device by means of a first device;
determining the feed of a mail piece into the feed channel, wherein a first sensor of the first device emits a signal upon the feed of an edge of the mail piece;
drawing in the mail piece by means of a second device to draw mail pieces into the feed channel;
triggering the scanning procedure of the surfaces of the mail piece by means of a third device for scanning in the feed channel;
establishing a position orientation by means of a fourth device for automatic position alignment of a mail piece, wherein the automatic position alignment ensues controlled by a sub-program for the controller according to which the mail piece has traversed the feed channel;
generating and storing an identifier number for the supplied mail piece, billing and accounting of the billing data associated with the identifier number, and printout of a record as a receipt for the user;
activating a sixth transport device to transport the mail pieces to a printer of a fifth device in order to print the marking on the mail piece;
activating the sixth transport device to transport the mail pieces and of corresponding deflectors on the transport belt for transportation up to the storage of the mail piece;
storing the mail piece; and
sealing the closure if no additional mail piece is to be deposited, or depositing of an additional mail piece if a user authorization for this is present.

25. A method as claimed in claim 24, comprising in the accounting of the billing data, including at least the identification data of the user and a postage value for the subsequent carriage and delivery by the mail carrier of the mail piece processed by means of the mail piece acceptance device.

26. A method as claimed in claim 24, comprising in the marking printed on the mail piece, including the previously generated identification number.

27. A method as claimed in claim 24, comprising executing a workflow program in the controller comprising the steps of:
querying whether a user input or user action has occurred in the first Query Step, wherein a wait loop branches back to the input of the first Query Step if no user input or, respectively, user action can be established;
identification/authorization of the user/the user input in the second step via a postal security device (PSD) of the mail piece acceptance device;
selecting of multiple possibilities and after this a determination of the pre-selection of the letter slit size in the third Query Step, fourth Query Step or fifth Query Step with subsequent arrival at a first point in the workflow plan, or a non-determination of the pre-selection with subsequently branching back to the beginning of the first Query Step;
executing a sub-program to set the slit size in the third step with subsequent arrival at a second point in the workflow plan;
executing a query for a mail piece depositing in a following depositing Query Step; and
emitting an output of a user instruction with a request for the user to deposit a mail piece if a mail piece deposit has not yet been established; or
implementing a sub-program to detect the orientation of the deposited mail piece when a mail piece deposit is established, and subsequent arrival at a third point in the workflow plan, wherein in the aforementioned sub-program a scanning of the front side and back side of the mail piece ensues in a sub-step and Query sub-Steps to detect the orientation of the deposited mail piece before arriving at point in the workflow plan in which cases are run through in which the front side or back side of the deposited mail piece was detected; and wherein otherwise, via a sub-step, with rejection of the mail piece in the mail piece acceptance device to the mail piece return the workflow branches back to emit an output of a user instruction in order to request the user take back the deposited mail piece, and wherein the workflow thereafter branches back to the beginning of the first Query Step;
generating an identifier number after reaching the third point in the one hundred twenty-ninth step of the workflow plan, wherein the identifier number is respectively associated with a scanned image of the front side and back side of the deposited mail piece and is stored before a fourth point in the workflow plan is reached;
executing a sub-program to establish a predetermined position orientation of the deposited mail piece after reaching the fourth point and before reaching a fifth point in the workflow plan;
generating an identifier for the mail piece, billing, accounting and application of a marking on the mail piece, and printing out a receipt after reaching the fifth point in the workflow plan;
executing a sub-program to store the deposited mail piece, wherein the respective storage container is selected corresponding to the pre-selection; and
storing information pertaining to the mail piece, the associated identifier number and the identifier printed on the mail piece at a data center before a further action Query Step is executed in order to establish whether the user still needs to deposit additional mail pieces at the mail piece acceptance device; wherein, when the latter case occurs, the workflow branches back from the further Query Step emit an output of a user instruction before additional inputs made by the user are registered and/or an additional mail piece is deposited by the same user;
otherwise, when an additional mail piece is not deposited by the same user and no further input is made within a predetermined time period, the workflow branches back to step to close the letter slot, wherein an End Step to end the workflow plan is reached upon closing.

28. A method as claimed in claim 27, comprising making a pre-selection made by the user to set the deposit opening of the mail piece acceptance device is queried via the Query Steps, wherein the workflow branches to the second pre-selection II if the first pre-selection I was not detected as having been selected; and if the second pre-selection II is detected as not having been selected, and the workflow then branches to the third pre-selection III etc. until the querying of a K-th pre-selection; wherein if the latter is not detected as having been chosen, the workflow branches back to the beginning of the first workflow step.

29. A method as claimed in claim 27, comprising, in the sub-program for setting the slit size in the third step, storing, in a first sub-step, the pre-selection made by the user for setting the deposit opening, and for output of the width and height of the desired deposit opening in the form of parameters which identify the Y- and Z-position for the closure jaws; wherein the corresponding Y- and Z-position is reached when the closure jaws are moved in the y-direction and z-direction in order to set the opening width of the closure of the feed channel for mail pieces.

30. A method as claimed in claim 27, comprising, in the sub-program to set the slit size in the third step, controlling, in a second sub-step, a motor M1 in sub-step and a fourth sub-step to control a second motor M2, wherein in the respective following third and fifth Query sub-Steps it is checked whether the Y-position and the Z-position have already been reached, and wherein otherwise the first motor M1 and the second motor M2 are activated further.

31. A method as claimed in claim 27, comprising, in the sub-program to adjust the slit size in the third step, in a sixth sub-step, after it was established in the third and fifth Query sub-Step that the Y-position and the Z-position have already been reached, starting a timer of the controller is started to run until a preset time/numerical value is reached, wherein the latter determines how long the mail piece acceptance device should remain ready to accept letters.

32. A method as claimed in claim 27, comprising in the sub-program to scan the front side and back side of a mail piece and for orientation detection of a mail piece in the mail piece acceptance device, in a first sub-step, scanning the front side and back side of the mail piece and to evaluate the scan data, wherein in the subsequent first Query sub-Step it is decided whether a mail piece falls short of the minimum dimensions that are provided by the postal carrier; wherein in such a case the workflow branches to the fourth point in order to reject the mail piece; wherein if the mail piece falls short of the minimum dimensions that are provided by the postal carrier, the workflow branches from the first Query sub-Step to a second Query sub-Step, wherein in the second Query sub-Step a check ensues as to whether the front side was detected by a scanning device arranged to the left of the feed channel for mail pieces; wherein otherwise, if this is not the case, the workflow branches to third Query sub-Step to check whether the front side was detected by a scanning device arranged to the right of the feed channel for mail pieces; wherein if the latter is likewise not the case, the workflow branches via a sixth sub-step to reject the mail piece for its return via a return bin; and wherein the workflow branches from the second Query sub-Step to a fourth Query sub-Step when the front side has been detected by a scanning device arranged to the left of the feed channel for mail pieces; and wherein the workflow branches from the third Query sub-Step to a fifth Query sub-Step when the front side has been detected by a scanning device arranged to the right of the feed channel for mail pieces; wherein subsequently in the fourth Query sub-Step it is established whether a mail piece is standing on its head because it was supplied on the edge with the envelope flap, and then the workflow branches to a first memory sub-step in order to store a first type of the alignment of the mail pieces corresponding to a first feed position; wherein otherwise, if a mail piece is not standing on its head, the workflow branches from the fourth Query sub-Step to a second memory sub-step in order to store a second type of the alignment of the mail pieces corresponding to a second feed position; wherein if a mail piece is standing on its head because it was supplied standing on the edge with the envelope flap, the workflow then branches to a third memory sub-step in order to store a third type of the alignment of the mail pieces corresponding to the third feed position; and wherein otherwise, if a mail piece is not standing on its head, the workflow branches from the fifth Query sub-Step to a fourth first memory sub-step in order to store a fourth type of the alignment of the mail pieces corresponding to the fourth feed position.

33. A method as claimed in claim 27, comprising, in the sub-program for storage of the deposited mail piece, executing Query sub-Steps so that a storage in the storage container ensues depending on the pre-selection of the size of the set opening width in the following sub-step upon meeting the query condition.
